(19) United States
(12) Patent Application Publication
(10) Pub. No.: US 2014/0032125 A1
(43) Pub. Date: Jan. 30, 2014

(54) Environment and Method for Rapid Analysis of Genomic Sequence Data

(71) Applicant: Trevor Hawkins, Walnut Creek, CA (US)

(72) Inventor: Trevor Hawkins, Walnut Creek, CA (US)

(73) Assignee: SIEMENS HEALTHCARE DIAGNOSTICS INC., Tarrytown, NY (US)

(21) Appl. No.: 14/000,468

(22) PCT Filed: Feb. 9, 2012
(86) PCT No.: PCT/US12/24466

§ 371 Date: Aug. 20, 2013

Related U.S. Application Data
(60) Provisional application No. 61/442,191, filed on Feb. 12, 2011.

(51) Int. Cl. G06F 19/00

(52) U.S. Cl. CPC G06F 19/3487
USPC 702/19

(57) ABSTRACT

In one aspect, the present disclosure describes a method that may include receiving an indication of selection of a first diagnostic algorithm of two or more of diagnostic algorithms for analyzing genetic sequence data, where the indication is associated with an identifier. The method may further include retrieving, from a storage medium, first genetic sequencing data associated with the identifier and analyzing, by one or more processors, the first genetic sequencing data using the first diagnostic algorithm to obtain at least one diagnostic result.

### RELATED APPLICATIONS

The present application claims priority to U.S. Provisional Application No. 61/442,191, entitled “Environment and Method for Rapid Analysis of Genomic Sequence Data” and filed Feb. 12, 2011, the contents of which is hereby incorporated by reference in its entirety.

### BACKGROUND

Sequencing of nucleic acids, such as deoxyribonucleic acid (DNA) and ribonucleic acid (RNA), involves determining the order of the nucleotide bases, namely adenine, guanine, cytosine, uracil, and thymine contained within a genetic sample (e.g., DNA from a blood sample). Various depths of information may be derived depending upon the type of sequencing performed. For example, traditional Sanger sequencing approaches typically involve the sequencing of small portions of DNA and/or RNA, while Next Generation Sequencing (NGS) approaches can be used to sequence much larger sequences. Genetic sequencing data obtained through an NGS approach might cover an entire DNA genome (also referred to as full genome sequencing (FGS)) or an RNA transcriptome (i.e., RNA molecules of a particular organism including one or more of mRNA, rRNA, tRNA, and other non-coding RNA).

### SUMMARY

In one aspect, the present disclosure describes a method that may include receiving an indication of selection of a first diagnostic algorithm of two or more of diagnostic algorithms for analyzing genetic sequence data, where the indication is associated with an identifier. The method may further include retrieving, from a storage medium, first genetic sequencing data associated with the identifier and analyzing, by one or more processors, the first genetic sequencing data using the first diagnostic algorithm to obtain at least one diagnostic result.

The one or more processors may include two or more networked processors. The two or more networked processors may be distributed in a cloud network environment in communication with a remote computing device. The method may further include providing the at least one diagnostic result to the remote computing device.

The first genetic sequencing data may include genome data. The first genetic sequencing data may include transcriptome data. The first genetic sequencing data may include data derived from at least one of a human, animal, plant, viral, or bacterial biologic sample.

The at least one diagnostic result may include at least one of (a) resistance patterns, (b) a respiratory panel, and (c) a transplantation panel. The method may further include determining a change in diagnosis practices relevant to the first diagnostic algorithm of the two or more diagnostic algorithms, and providing an alert associated with the identifier. The alert may include a recommendation for a new diagnostic algorithm of the two or more diagnostic algorithms.

Each respective diagnostic algorithm of the two or more diagnostic algorithms may be associated with at least one category of two or more categories, and the two or more categories may include one or more of virology, bacteriology, oncology, microbiology, and pathology. The method may further include generating, for presentation at a user device, interface information including two or more controls corresponding to the two or more diagnostic algorithms. Each respective control of the two or more controls may be associated with a respective diagnostic algorithm of the two or more diagnostic algorithms. Generating the interface information may include associating each respective control of the two or more controls with a respective visual indication corresponding to at least one category of the two or more categories. Receiving the indication of selection of the first diagnostic algorithm may include receiving the indication of selection of a first control of the two or more controls from the user device, where the first control corresponds to the first diagnostic algorithm. Associating each respective control of the two or more controls with the respective visual indication may include spatially organizing the two or more controls into two or more groups, where each group of the two or more groups corresponds to a respective category of the two or more categories.

The first diagnostic algorithm of the two or more diagnostic algorithms may be associated with at least one classification of two or more classifications. The two or more classifications may include one or more of research use, clinical study, certified, clinical diagnosis, and federal drug administration (FDA) approved. Each respective diagnostic algorithm of the two or more diagnostic algorithms may be associated with a respective price. The price may be based in part upon the respective classification of the two or more classifications. The method may further include generating, for presentation at a user device, interface information including two or more controls corresponding to the two or more diagnostic algorithms. Each respective control of the two or more controls may be associated with a respective diagnostic algorithm of the two or more diagnostic algorithms. Generating the interface information may include associating each respective control of the two or more controls with a respective visual indication corresponding to at least one classification of the two or more classifications. Receiving the indication of selection of the first diagnostic algorithm may include receiving the indication of selection of a first control of the two or more controls from the user device, where the first control corresponds to the first diagnostic algorithm. Associating each respective control of the two or more controls with the respective visual indication may include spatially organizing the two or more controls into two or more groups. Each group of the two or more groups may correspond to a respective classification of the two or more classifications.

The method may further include generating report data including the at least one diagnostic result. Generating the report data may include formatting the report data for review by a user. The method may further include retrieving, from a second storage medium, medical record data. The report data may include a portion of the medical record data. The identifier may be associated with a set of meta data including demographic information, and the report data may include a portion of the demographic information.

The method may further include determining, by the one or more processors, based upon the at least one diagnostic result, a second diagnostic algorithm of the two or more diagnostic algorithms, and providing, for review at a user device, an option for selecting analysis of second genetic sequencing data using the second diagnostic algorithm. The method may further include retrieving, from a second storage medium, medical record data. Determining the second diagnostic algorithm of the two or more diagnostic algorithms may include reviewing a portion of the medical record data. Determining the second diagnostic algorithm of the two or more diagnostic algorithms may include determining a popularity associated with the second diagnostic algorithm. Determining the second diagnostic algorithm of the two or more diagnostic algorithms may include determining a user rating associated with the second diagnostic algorithm. The method may further include receiving an indication of selection of the second diagnostic algorithm. Responsive to the indication of selection, the method may further include analyzing, by the one or more processors, the second genetic sequencing data using the second diagnostic algorithm to obtain at least one second diagnostic result. The second genetic sequencing data may include a different type than the first genetic sequencing data. The second genetic sequencing data may include the first genetic sequencing data. The method may further include generating report data, where

the report data may include the at least one diagnostic result and the at least one second diagnostic result. Generating the report data may include formatting the report data for review by a user.

Prior to analyzing the first genetic sequence data, the method may further include validating the first genetic sequence data. Validating the first genetic sequence data may include comparing a type of the first genetic sequence data to a predetermined type of genetic sequence data for use with the first diagnostic algorithm. The type may include at least one of genome, transcriptome, DNA, and RNA. Validating the first genetic sequence data may include determining a recency of the first genetic sequence data.

In one aspect the present disclosure describes a system. The system may include a storage medium including first genetic sequence data, one or more processors, and memory. The memory may store instructions that, when executed, cause the processor to receive an indication of selection of a first diagnostic algorithm of two or more diagnostic algorithms for analyzing genetic sequence data. The indication may be associated with an identifier. The instructions may further cause the processor to retrieve, from the storage medium, first genetic sequencing data associated with the identifier, and analyze, by the one or more processors, the first genetic sequencing data using the first diagnostic algorithm to obtain at least one diagnostic result.

The one or more processors may include two or more networked processors. The two or more networked processors may be distributed in a cloud network environment. The instructions may further cause at least one of the two or more networked processors to provide the at least one diagnostic result to a remote computing device. The at least one diagnostic result may include at least one of (a) resistance patterns, (b) a respiratory panel, and (c) a transplantation panel. Each respective diagnostic algorithm of the two or more diagnostic algorithms may be associated with at least one category of two or more categories, the two or more categories including one or more of virology, bacteriology, oncology, microbiology, and pathology.

In one aspect the present disclosure describes a non-transitory computer readable medium. The computer readable medium may store instructions that, when executed by a processor, cause the processor to receive an indication of selection of a first diagnostic algorithm of two or more diagnostic algorithms for analyzing genetic sequence data, where indication may be associated with an identifier. The instructions, when executed by the processor, may further cause the processor to retrieve first genetic sequencing data associated with the identifier, and analyze the first genetic sequencing data using the first diagnostic algorithm to obtain at least one diagnostic result.

The processor may include two or more networked processors. The two or more networked processors may be distributed in a cloud network environment in communication with a remote computing device. The instructions, when executed, may further cause at least one of the two or more networked processors to provide the at least one diagnostic result to the remote computing device.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is a diagram of an example system for analysis of genetic sequence data;

FIG. 2 is a flow chart of an example method for analysis of genetic sequence data;

FIGS. 3A through 3C are screen shots of an example user interface to a system for analysis of genetic sequence data;

FIGS. 4A through 4F are screen shots of an example user interface for a patient medical information system;

FIG. 5 is a diagram of an example network environment for analysis of genetic sequence data;

FIG. 6 is a flow chart of an example method for adding a new analysis application to a system for analysis of genetic sequence data;

FIG. 7 is a block diagram of another example network environment for analysis of genetic sequence data;

FIG. 8 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

In some implementations, the present disclosure may be directed to a system and method for analysis of genetic sequence data. The analysis, in some implementations, may provide diagnostic data in response to a request for analysis in light of a particular disease, condition, genetic disposition, symptom or set of symptoms, disorder, or medical history data. In some implementations, a user may be presented with a number of analysis applications for selection, where each analysis application may be associated with a particular genetic disease, condition, genetic disposition, symptom or set of symptoms, or disorder. The analysis applications, in some implementations, may be grouped into two or more diagnosis categories such as, in some examples, virology, bacteriology, oncology, microbiology, and pathology.

In some implementations, analysis may provide results in the form of one or more of a resistance pattern, a respiratory panel, and a transplantation panel. The analysis, in some implementations, may take into consideration medical data regarding a patient associated with the analysis. The patient associated with the analysis, in some examples, may be the source of the sample, an immediate relative of the source of the sample, a potential reproductive partner of the source of the sample, or a potential organ or other biological material donor for the source of the sample. The results of the analysis, in some implementations, may be provided to a medical practitioner to aid in making a determination in the care of a patient. In some examples, the medical practitioner may be engaging with the patient in genetic counseling, donor selection, or selection of an appropriate treatment or therapy for a patient.

In some implementations, the results of the analysis may be made available to a third party such as, in some examples, a research organization, hospital, or university, to aid in research. In some implementations, the results of the analysis made available to the third party may be provided as partial or anonymous data. In some examples, results of the analysis may be provided to aid in developing a new analysis application, to generate statistics regarding a patient population, or to generate data regarding the outcome of a particular treatment of a medical condition.

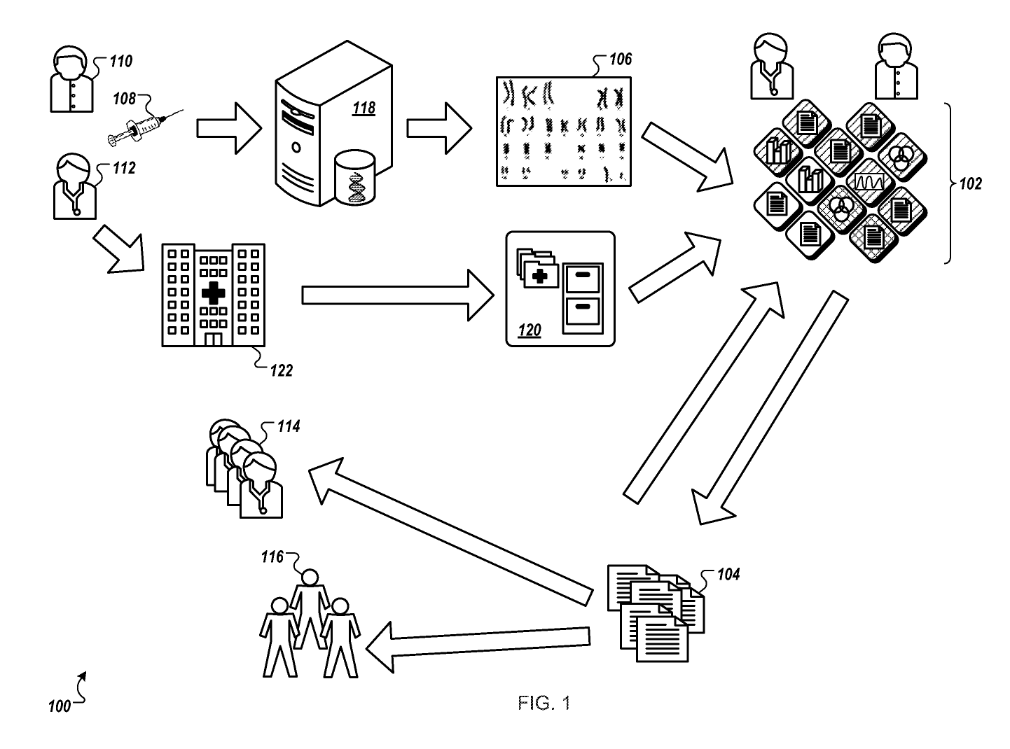

Turning to FIG. 1, a system 100 for analysis of genetic data, in some implementations, may include a set of genetic analysis applications 102 for generation of report data 104 based upon analysis of genetic sequence data 106. A patient 110 or a physician 112 may select one or more of the genetic analysis applications 102, in some implementations, to obtain diagnosis information in the form of the report data 104. The report data 104 may be used, in some examples, to counsel the patient 110 or direct a treatment of the patient 110. The report data 104, in some implementations, may be provided to medical professionals 114 or researchers 116 for clinical and/or research purposes.

The genetic sequence data 106 provided to the genetic analysis applications 102, in some implementations, may be obtained from a sample 108, such as a blood draw from the patient 110. The sample 108, in some implementations, may include plant, animal, virus, and/or bacterial genetic material. In some examples, the sample 108 may include human genetic material for medical testing, animal genetic material for veterinary testing, genetic material for defense testing, or plant or animal material for industrial or commercial food testing. The sample 108, in some implementations, may be provided to a genetic sequencing system 118 (e.g., introduced to a genetic sequencing machine or shipped to a sequencing facility) to generate the genetic sequence data 106. In some examples, the genetic sequence data 106 may include partial or complete (e.g., genomic, transcriptome) sequence data of DNA, RNA, or both.

In addition to the genetic sequence data 106, in some implementations, medical record information 120 may be provided to one or more of the genetic analysis applications 102. The medical record information 120 may be used by one of the genetic analysis applications 102, in some examples, to improve diagnosis or to generate more complete report data 104. In some implementations, the physician 112 and/or patient 110 may have the authority to authorize access to the medical record information 120 by the genetic analysis applications 102, for example through a medical system 122 (e.g., hospital system, insurance system, doctor's office, government medical record repository, etc.).

In some implementations, the patient 110 and/or physician 112 may access the genetic analysis applications 102 via a user interface for genetic analysis application selection. The genetic analysis applications 102, in some implementations, may include a variety of output information, such as, in some examples, raw information (e.g., identification, quantification, etc.), baseline comparison information, and treatment recommendation information. In some implementations, the report data 104 may be maintained in a medical reporting system including a portion of the medical data 120. For example, the patient 110 and/or the physician 112 may have access to report data 104 alongside additional medical information (e.g., medical history, medication history, therapeutic history, surgical history, etc.) regarding the patient 110.

In some implementations, the report data 104 may vary in content or usefulness depending in part upon an acceptance level of a particular genetic analysis application 102. For example, a first genetic analysis application 102 may provide analysis based upon one or more algorithms that have been certified by an approval board and thus may provide more trusted and, in some cases, richer information than a second genetic analysis application 102. The second genetic analysis application 102, further to the example, may provide analysis based upon the ongoing work of a graduate student at a university. In some implementations, the genetic analysis applications 102 may be organized in a class hierarchy based, in part, upon a level of acceptance of the analysis provided by each of the genetic analysis applications 102. In some examples, a class hierarchy may include a board certified class (e.g., United States Food and Drug Administration (FDA), Conformité Européenne In-Vitro Diagnostic Directive (CE IVDD), State food and Drug Administration of the People's Republic of China (SFDA), etc.), a pending certification class (e.g., involved in an ongoing board certification process), and a research use class (e.g., an unproven algorithm that has shown potential in one or more studies). Other gradations are possible. In a particular example where the system 100 is implemented in the United States, genetic analysis applications having FDA approval may be arranged in a higher class hierarchically than one or more genetic analysis applications that have received certification in one or more other countries but have not yet been certified in the United States.

In some implementations, based upon results obtained via a first genetic analysis application, the system 100 may recommend one or more additional genetic analysis applications 102 to obtain further information regarding the genetic sequence data 106 and/or the patient 110. For example, if a particular disease is detected, additional analysis using another one of the genetic analysis applications 102 may provide the physician 112 with an indication of which drug(s) may be best suited to the patient 110 for treatment of the detected disease. In another example, based upon a resistance pattern of mutations, a recommendation may be presented for further information regarding additional in vivo or in vitro diagnostic tests of one or more further genetic analysis applications.

In some implementations, the system 100 may require additional genetic sequence data 106 to run a follow-on genetic analysis application 102. For example, genetic sequence data 106 of a virus may be analyzed to determine a type of virus afflicting the patient 110, while genetic sequence data 106 of the patient 110 may be analyzed to select a treatment for the patient 110 to combat the identified virus.

In some implementations, based upon ongoing research in the area involving a selected genetic analysis application, the physician 112 and/or the patient 110 may be alerted of updated or additional genetic analysis application(s) 102 associated with previously performed genetic analysis. For example, on July 8, the physician 110 may request that the system 100 run the genetic sequence data 106 against a first genetic analysis application 102, obtaining first report data 104. If, on July 9, in some examples, a fix to an error identified in the first genetic analysis application 102 is received, an upgraded version of the first genetic analysis application 102 is added to the system 100, or a new genetic analysis application 102 becomes available that is relevant to a portion of the first report data 104 (e.g., for providing further information relevant to the patient 110), the system 100 may provide an alert to the physician 112 and/or the patient 110 regarding the availability of the updated information. In some implementations, the physician 112 and/or the patient 110 may be alerted via contact information contained within the medical records 120 or through an account established with the system 100 (e.g., web portal account).

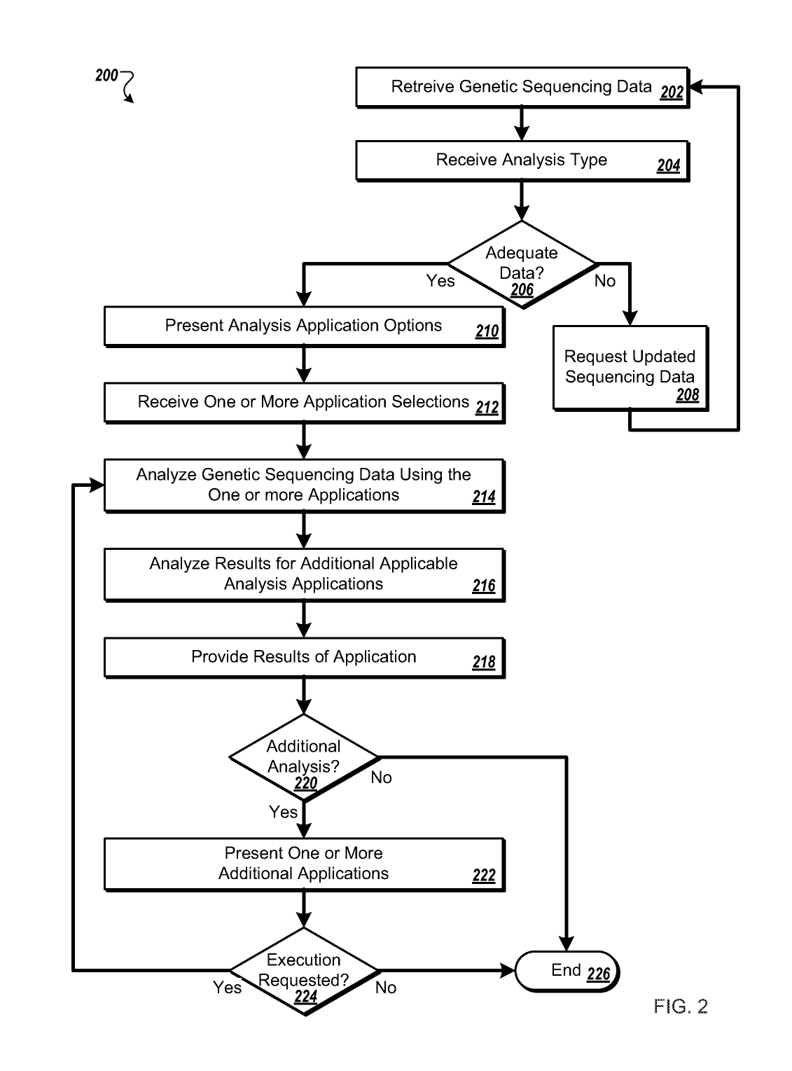

Turning to FIG. 2, in some implementations, a method 200 for analysis of genetic data may begin with retrieving genetic sequence data (202). The genetic sequence data, in some implementations, may include one or more of human, plant, animal, bacterial, or viral genetic sequence data, including DNA and/or RNA. In some implementations, the genetic sequence data includes a full genome and/or transcriptome sequencing. The genetic sequence data, in some implementations, may be accessed from a networked storage device. The genetic sequence data may be retrieved, in some implementations, using one or more pieces of metadata associated with the genetic sequence data such as, in some examples, a patient identifier, sample identifier, sample type (e.g., human, viral, bacterial, etc.), a sample acquisition date, and a genetic sequence data storage date. In a particular example, any and all genetic sequence data related to a particular patient identifier, including one or more individually sequenced samples, may be retrieved. Retrieving the genetic sequence data, in some implementations, may include retrieving a link or pointer to a storage location where the genetic sequence data is stored.

In some implementations, at least one type of genetic analysis may be received (204). In some implementations, types of genetic analysis may include human, plant, animal, viral, and bacterial. A user, in some implementations, may select a category of genetic sequencing analysis, for example using controls presented within a graphical user interface menu. In some implementations, the analysis type may be derived from metadata associated with the genetic sequence data. For example, if the genetic sequence data is flagged as being viral in nature, then a viral type of genetic sequence data analysis may be inferred without express receipt of a type of genetic analysis.

In some implementations, adequacy of genetic sequence data may be determined (206). In some implementations, metadata associated with the genetic sequence data may be analyzed to determine if the genetic sequence data is appropriate for the desired analysis type. A sample date associated with the retrieved genetic sequence data, in some implementations, may be reviewed to determine if a sample has “expired” in relation to diagnosis-based analysis (e.g., a viral sample is greater than N months old, etc.). In one example, if a user supplies a requested type of genetic sequencing analysis (e.g., bacterial), the type of genetic sequence data retrieved (e.g., human, plant, animal, viral, or bacterial, etc.) may be compared to the type of analysis to verify adequacy of data.

In some implementations, a requestor may be provided the opportunity to review and approve the genetic sequence data, for example in a graphical user interface. The requestor, for example, may verify information regarding the retrieved genetic sequence data, including metadata and/or a graphical representation of the contents of the genetic sequence data, to make the determination whether the retrieved genetic sequence data is sufficient (e.g., a being relevant type of sequencing data, referring to an anticipated sample, etc.) for the requested genetic analysis.

If the genetic sequence data is determined to be inadequate (206), in some implementations, a request may be made for updated, additional, and/or supplemental genetic sequence data (208). In some implementations, at a user interface, a user may be prompted to direct the system to another set of genetic sequence data (e.g., bacterial rather than human) or to an updated set of genetic sequence data (e.g., a sample obtained within the past month rather than over three months ago). In some implementations, a message may be relayed to a requesting entity such as, in some examples, a physician's office, hospital system, or research laboratory, to verify the genetic sequence data provided in relation to a particular analysis request. For example, an analysis request containing a set of analysis parameters (e.g., user account identifier, sequencing data identifier, analysis application identifier, etc.) may be received outside of a real-time bi-directional user interface request (e.g., telephone request, facsimile request, courier request, electronic message or e-mail request, or other non-real-time submission). In other implementations, an error indication may be provided to the requester, such as at a user interface, prompting the user to start over with a request. The error condition, in some implementations, may include a mechanism for receiving help in placing a genetic sequencing analysis request.

If the genetic sequence data is determined to be adequate (206), in some implementations, analysis application options may be presented (210). In some implementations, based upon type of genetic sequence data received, analysis applications presented may include a subset of all genetic analysis applications available in the system (e.g., human DNA only, viral RNA only, etc.). The analysis applications, in some implementations, may be presented based in part upon permissions associated with the requestor. For example, one or more genetic sequencing analysis applications may be organization-specific, such as private applications being developed by a particular university, hospital, or research organization. In another example, permissions may include physician-only applications (e.g., to be used for diagnosis purposes) vs. patient-available applications (e.g., to be used to reference or genetic counseling purposes). Other automatic filtering of genetic sequencing analysis applications is possible.

In some implementations, a requestor may be provided with one or more mechanisms for filtering the genetic analysis application selections presented. In some implementations, filters may be based upon one or more of application category, symptom(s), disease, condition, disease indicator, or proposed treatment. An application classification, in some implementations, may be applied to filter the genetic analysis application within a presentation menu. For example, the genetic analysis applications may be classified based in part upon a level of acceptance of the analysis provided by each of the genetic analysis applications 102. In some examples, classifications may include a board certified class, a pending certification class, and a research use class. In some implementations, a requestor may filter genetic analysis options based upon price, popularity, peer recommendation, user reviews, estimated time to completion, or other determining factors.

In some implementations, rather than initially presenting one or more applications, a menu may provide a user with a number of application categories, a search box, a number of symptoms, diseases, conditions, disease indicators, patient treatments, or other ways for narrowing a set of genetic analysis applications to those relevant to the requestor.

In some implementations, selection of one or more genetic analysis applications may be received (212). Selection, in some implementations, may be made through an genetic analysis application “store”, where a requestor may select and order one or more genetic analysis applications. For example, a requestor may select one or more genetic analysis applications, proceed to checkout, be presented with a bill, and order execution of the requested genetic analysis applications upon the identified genetic sequence data.

In some implementations, a requestor may ask one or more “questions” of the system, in the form of medical diagnosis (e.g., what is my risk for having a child with sickle-cell anemia, what is the patient's risk of multiple sclerosis, etc.). In some examples, the requestor may be provided with a search box type interface for typing in a question or a menu of possible questions (e.g., arranged in relation to symptoms, conditions, disorders, alphabetically, etc.). In another example, a requestor may be provided with a search box type interface to submit a key word or key phrase (e.g., “sickle-cell”) and, in response, receive one or more questions or topics related to the key word or key phrase (e.g., “sickle-cell treatment”, “sickle-cell trait detection”, “sickle-cell condition detection”). In response to providing a question or topic, in some implementations, the requestor may be presented with a selection of genetic analysis applications or an order fulfillment display indicating a selected genetic analysis application which may provide an answer to the question provided.

In some implementations, the selection of a genetic analysis application may be indicative of a type of report generated in response to the analysis. For example, separate genetic analysis applications for execution of the same or similar analysis algorithm(s) (e.g., an algorithm for analyzing the genetic sequencing data to obtain particular information) may be offered for selection based upon output style. In a particular example, separate genetic analysis applications may be provided for obtaining clinical report data, personal (e.g., layperson approachable) report data, and research report data. In some implementations, during the process of selecting and ordering one or more genetic analysis applications, a requestor may additionally specify a desired type of report. In some implementations, a requestor may be presented with the opportunity to select one or more styles of output. In some examples, report output may include one or more of an electronic document report, facsimile report, electronic medical record analysis (e.g., for addition to a patient medical information portal application), Web browser (e.g., HTML-based) report, spreadsheet report, and/or hard copy (e.g., via parcel post) report.

In some implementations, genetic sequence data may be analyzed using the one or more selected genetic analysis applications (214). In some implementations, the genetic analysis applications may be used to analyze an individual gene or groups of genes in the provided sequencing data. The request, in some implementations, may be scheduled and executed on one or more processors within a cloud computing environment. In some implementations, one or more genetic analysis applications may be executed in parallel. One or more genetic analysis applications may be scheduled to execute back-to-back, in some implementations. For example, a second genetic analysis application may depend upon information obtained from a first genetic analysis application, causing the system to schedule the second genetic analysis application to follow the completion of at least a portion of the analysis of the first genetic analysis application. The requestor, in some implementations, may be presented with a time estimate for completion of the requested genetic analysis application(s). In some implementations, during execution, the user may be presented periodically with a status indicator. In some examples, a status indicator may include an estimated time remaining, estimated percentage of a task performed, or a current state of the task (e.g., analyzing, formatting report data, etc.).

In some implementations, results of the analysis done by one or more of the genetic analysis applications may be analyzed to determine one or more additional applicable genetic analysis applications (216). Based upon information obtained through the results of a first genetic analysis application, in some implementations, one or more related genetic analysis applications may be identified which build upon the information or provide a greater level of detail regarding the information. The system, in some implementations, may reference particular output data from a first genetic analysis application, such as a positive indication of the presence of a particular genetic marker, which may be associated with one or more further genetic analysis applications (e.g., determining whether or not a related genetic marker exists in the sample, determining whether or not a condition commonly associated with the genetic marker appears in the genetic sequence data, etc.). In some implementations, one or more further genetic analysis applications may be recommended based in part upon a rating or popularity associated with each genetic analysis application. For example, a genetic analysis application may be recommended based in part upon a prevalence of selection of the genetic analysis application by other users after having received similar results from a prior genetic analysis application to results obtained by the requestor (e.g., other users who received a positive identification of sick-cell anemia trait).

In some implementations, results of the analysis executed upon e.g., the genetic sequence data by the selected genetic analysis application(s), may be provided to a user (218). The user, in some examples, may include the requestor, a physician or other medical professional who directed the requestor to obtain the information provided by the analysis, the patient, or another medical professional (e.g., authorized by the requestor, the patient, or other affiliated medical professional to review the information provided by the analysis). The analysis results, in some implementations, may be provided to the user as report data. In some examples, report data may be provided in a graphical user interface or downloaded to a user device in one or more electronically readable files. In some implementations, the report data may be appended in part to medical records associated with a patient. In some implementations, a portion of the analysis results may be provided (e.g., in an anonymous or semi-anonymous manner) to a third party for research purposes, or an insurance company or other organization affiliated with the patient may use a portion of the analysis for statistical information or other group analysis. In some implementations, the report data may be tailored for consumption by a particular type of end user. For example, report data provided to a medical professional may contain different information or a different presentation style than report data provided to an end patient.

In addition to analysis results, in some implementations, a requester may be provided with one or more tools for use in interpreting the results of the analysis. For example, one or more help menus, training videos, question & answer segments, or live report consultation options (e.g., telephone, video conference, text messaging conference, etc.) may be provided to the requester to aid in the understanding of the test results. In some implementations, a social networking style interface may be provided to the requester to provide the requester with a structure for receiving further information regarding the analysis results. In some implementations, a social networking style interface for interpreting and understanding genetic analysis results may include information regarding further diagnosis, one or more therapies, treatments, or potential cures available, or access to third parties affiliated in an area associated with the genetic analysis results (e.g., hospitals, doctors, pharmaceutical companies, support groups, charitable organizations, etc.). Access to third parties, in some examples, may include membership in a social networking group, one or more advertisements posted within the social networking site, or references to additional educational materials (e.g., books, research studies, articles, etc.).

If additional applicable genetic analysis applications are identified (220), in some implementations, the user may be presented with the additional genetic analysis applications (222). In some examples, a user may be prompted within the genetic analysis results (e.g., as a portion of the report data), through the user interface session used to request the previous genetic analysis application, in a separate communication (e.g., email, text message, telephone message, etc.), or via a third party. For example, a third party, such as a physician, insurance company, hospital, lab technician, specialist, or research facility, may be alerted of additional genetic analysis applications available. In some implementations, in addition to being presented with one or more genetic analysis applications, the requester may be presented with information regarding the potential benefits of requesting the recommended genetic analysis application(s), a price associated with the recommended genetic analysis application(s), and/or an example of the type of output (e.g., report data, result analysis) available through the recommended genetic analysis application(s).

If the user, in turn, authorizes the execution of one or more of the one or more genetic analysis applications (224), in some implementations, genetic sequence data may be analyzed using the additional genetic analysis application(s) (214). The analysis, in some implementations, may include similar scheduling, updating, and provision of report data as the originally requested genetic analysis applications. In some implementations, report data from subsequently requested genetic analysis application(s) may be combined with previous report data, for example to develop a more detailed analysis result.

In some implementations, additional analysis may come available after some time has passed. For example, one or more genetic analysis applications may become certified, be newly added to the system, or be updated, supplemented, or revised to provide additional (or corrected) analysis results. In this circumstance, at step 220, a requester or other user may be alerted via one or more contact mechanisms (e.g., email, text message, telephone message, postal letter, etc.) of the availability of the new or updated genetic analysis application(s). In some implementations, the user may log in through a secure or authorized system to receive detailed information regarding the genetic analysis application(s).

Although described in relation to a particular series of steps, in some implementations, the method 200 may include more or fewer steps, and/or the steps presented in the method 200 may be executed in a different order. For example, in some implementations, determination of the adequacy of the genetic sequence data (206) may occur after one or more genetic analysis applications has been selected (212). In some implementations, a first requester (e.g., lab technician) may request genetic analysis based upon a first genetic analysis application (212), while the results of the analysis may be provided (218) to a second user (e.g., physician) for review.

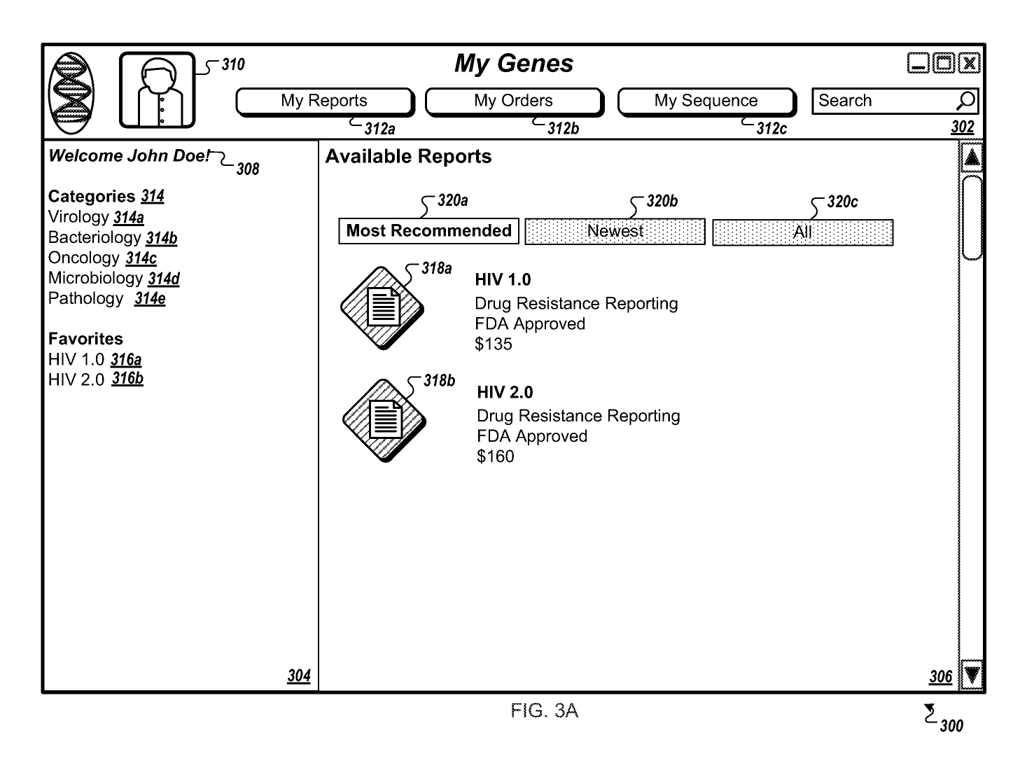

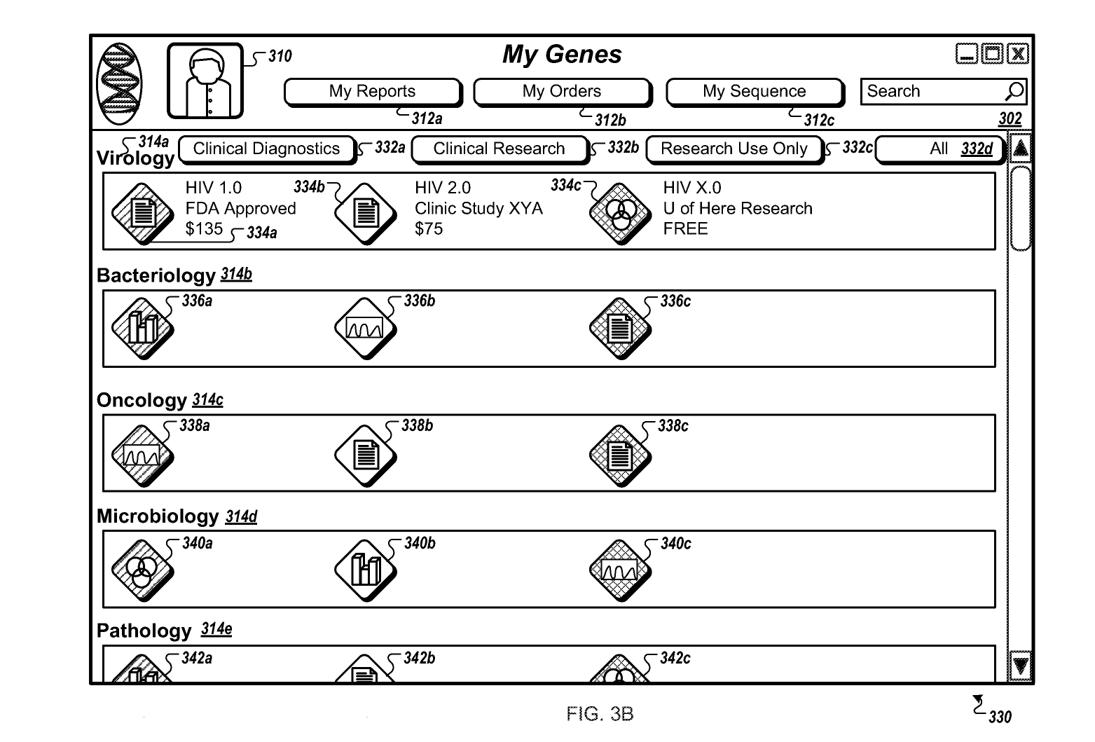

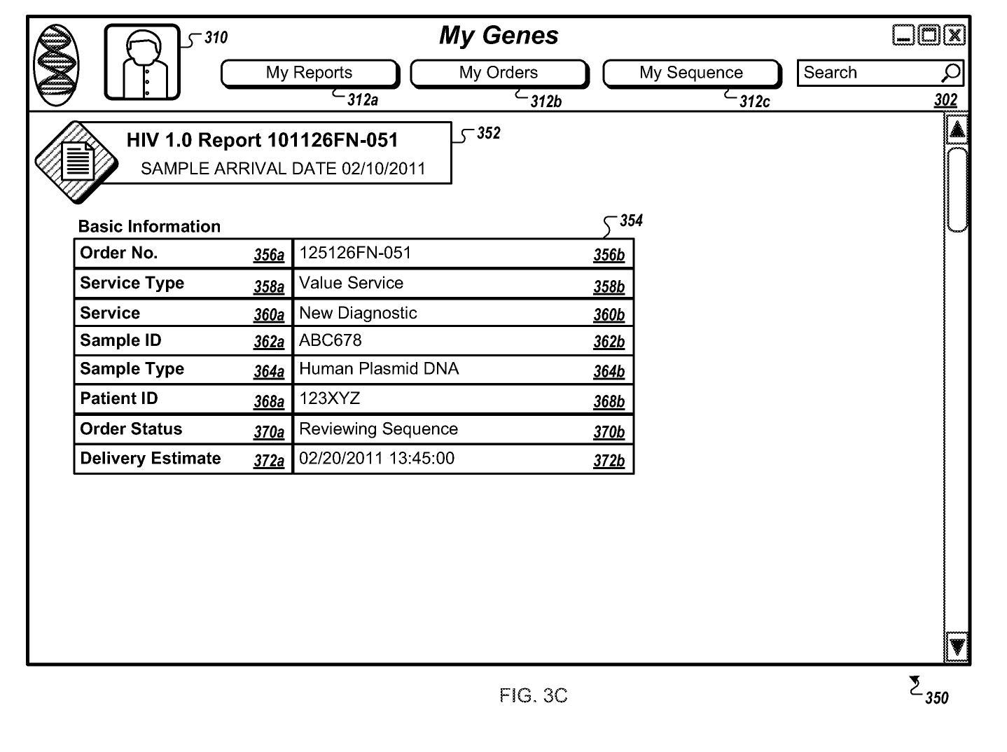

FIGS. 3A through 3C, in some implementations, present example user interfaces for reviewing, selecting, and requesting execution of genetic analysis applications. Turning to FIG. 3A, a screen shot 300 for an interface for placing orders for genetic analysis applications, in some implementations, may include a header bar 302, a side menu bar 304, and a main window 306. A user such as “John Doe” as named in a welcome message 308 at the top of the side menu bar 304 and presented in a user image 310 in the header bar 302, in some implementations, may review the screen shot 300, including controls to personal information such as a “My Reports” control 312a, a “My Orders” control 312b, and a “My Sequence” control 312c after having logged into an account with a genetic analysis application provider (e.g., “My Genes”, as listed at the top of the header bar 302). In some implementations, the user “John Doe” may be an individual patient or the head of a household (e.g., which may include access to one or more additional family members such as a spouse and one or more children). The user “John Doe”, in some implementations, may be a physician, lab technician, researcher, veterinarian, technician, or other professional interested in obtaining results of analysis of genetic sequence data.

Turning to the side menu bar 304, in some implementations, categories 314 of available genetic analysis applications may include, in some implementations, a virology category 314a, a bacteriology category 314b, an oncology category 314c, a microbiology category 314d, and a pathology category 314e. Beneath the categories 314, a listing of favorites 316, in some implementations, may include one or more genetic analysis applications that the user “John Doe” has previously requested, such as an HIV 1.0 genetic analysis application 316a and an HIV 2.0 genetic analysis application 316b. In some implementations, the favorites 316 may include the most popular genetic analysis applications across all users of the genetic analysis application system, or across a particular segment of users. In some examples, the favorites 316 may include the most popular genetic analysis applications across all individual users, medical professional users, veterinarian users, food scientist users, or researcher users. In some implementations, each of the categories 314 and the favorites 316 may be selectable to generate further information. For example, selection of a particular category 314 may, in some implementations, cause the presentation of one or more genetic analysis applications listed under the selected category 314. In some implementations, selection of one of the favorites 316, such as HIV 1.0 genetic analysis application 316a, may cause the generation of an order menu to request execution of the selected favorite 316 against identified genetic sequence data.

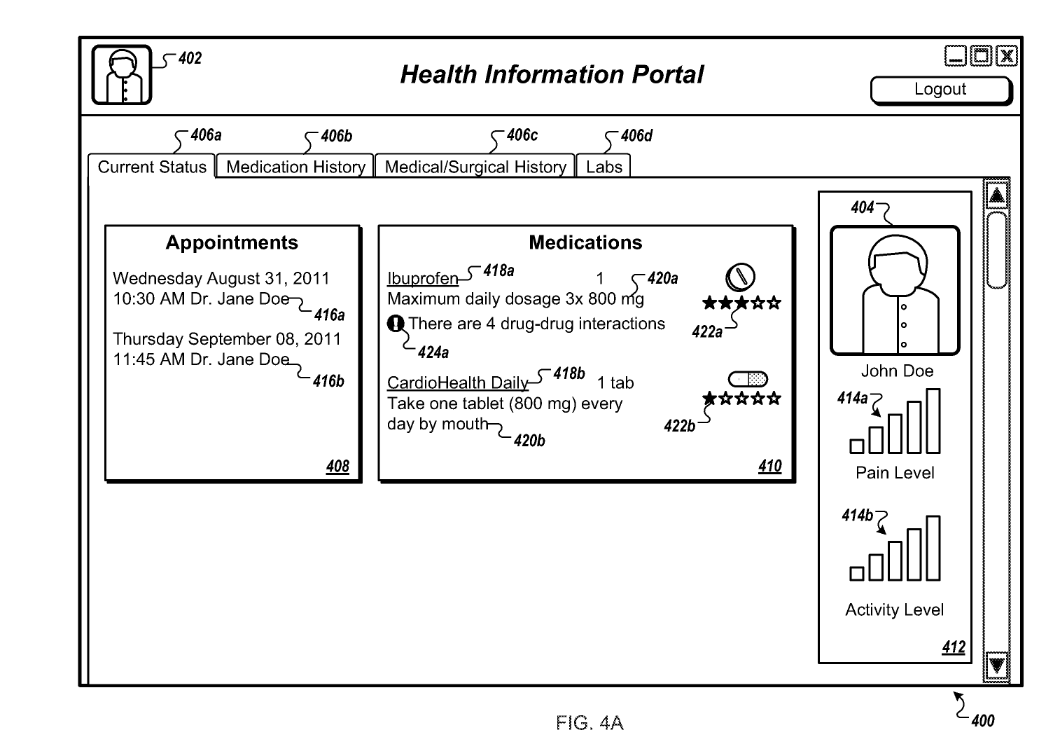

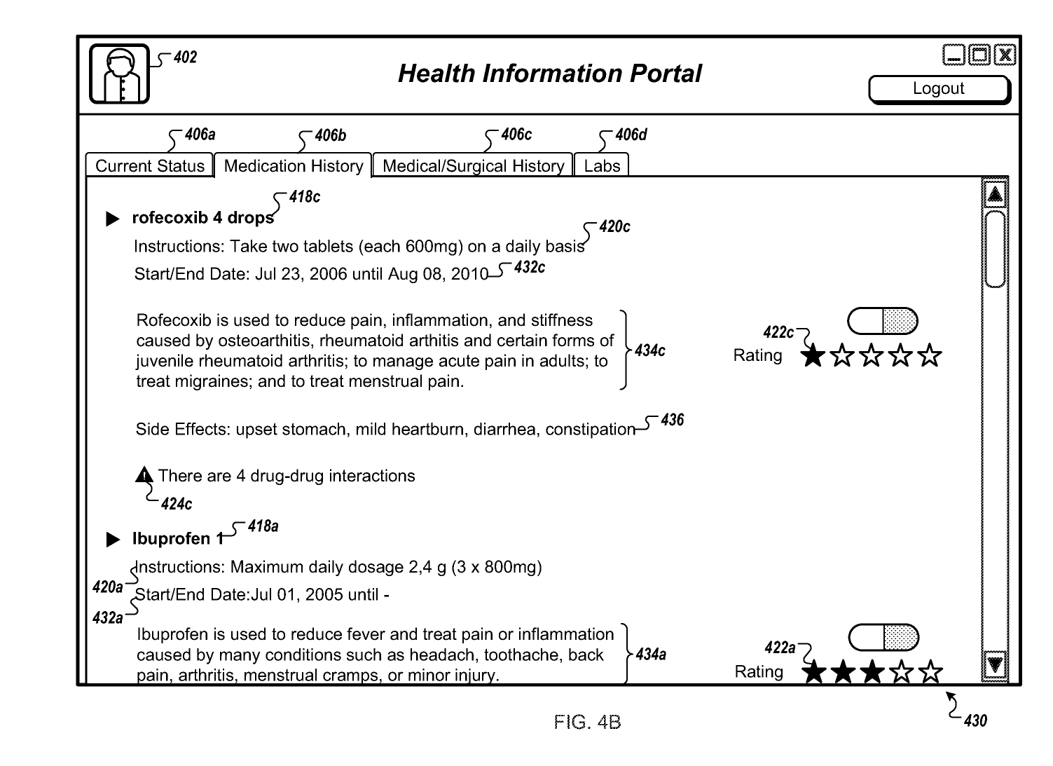

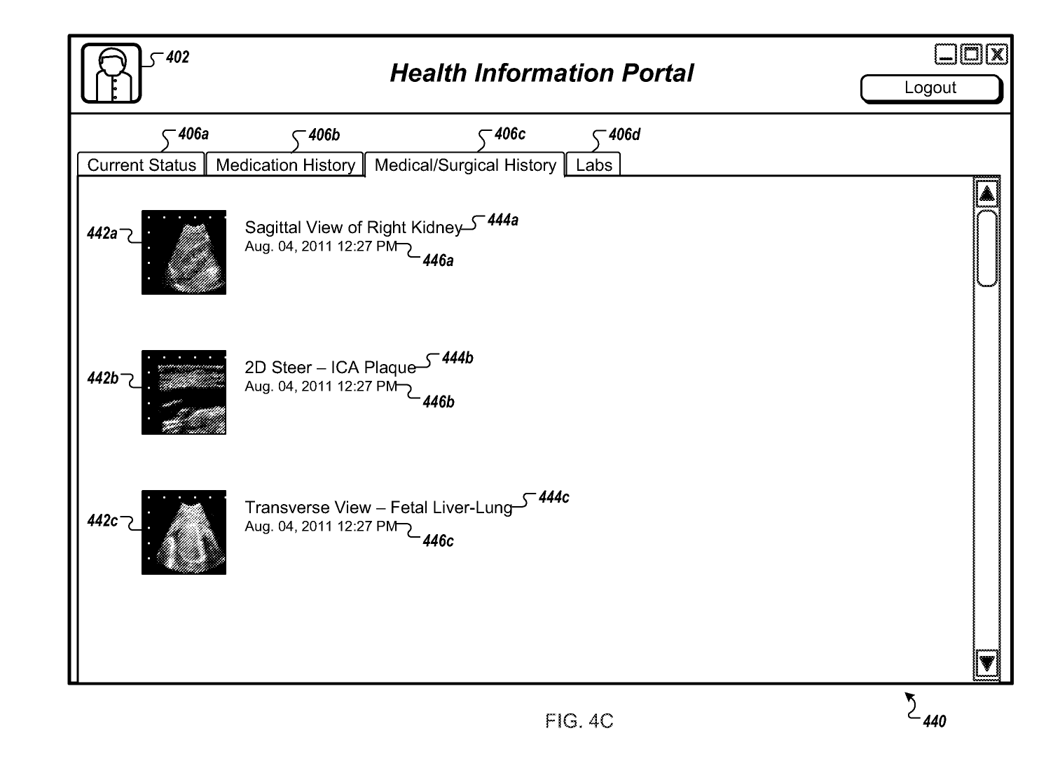

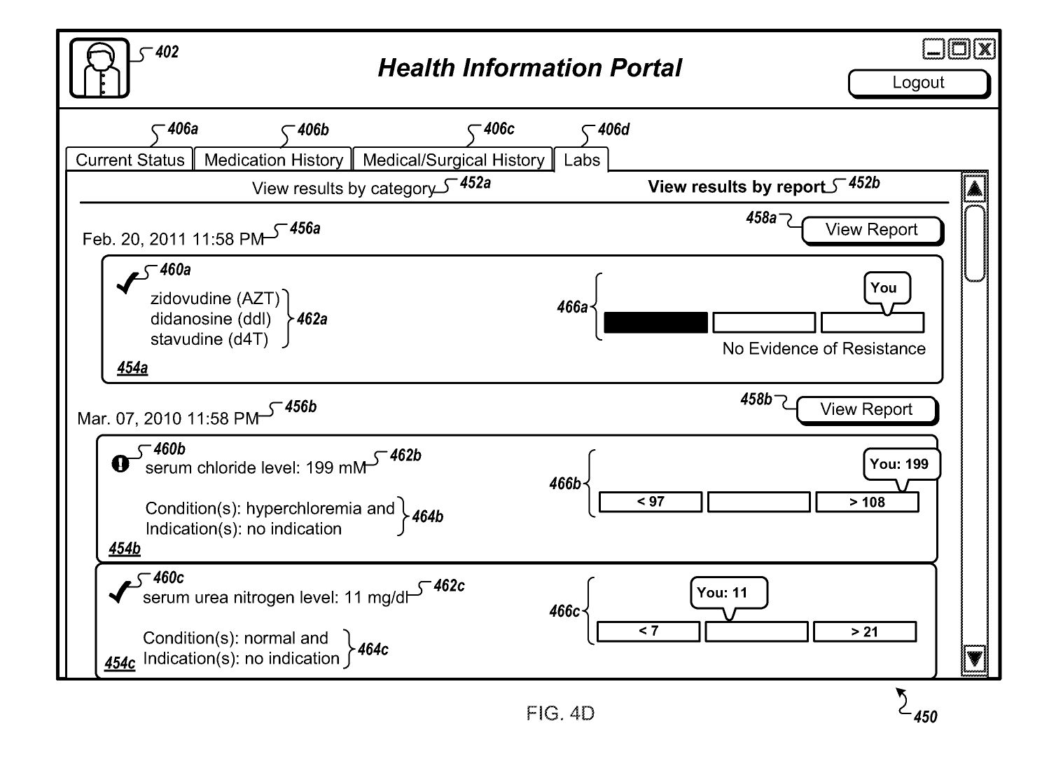

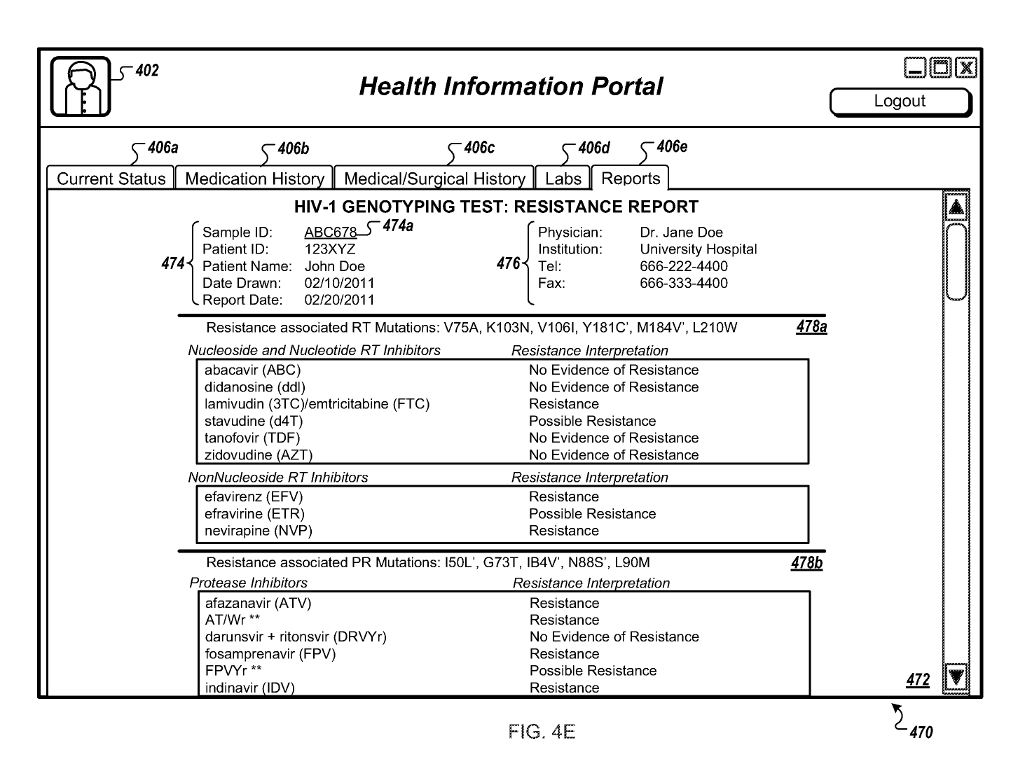

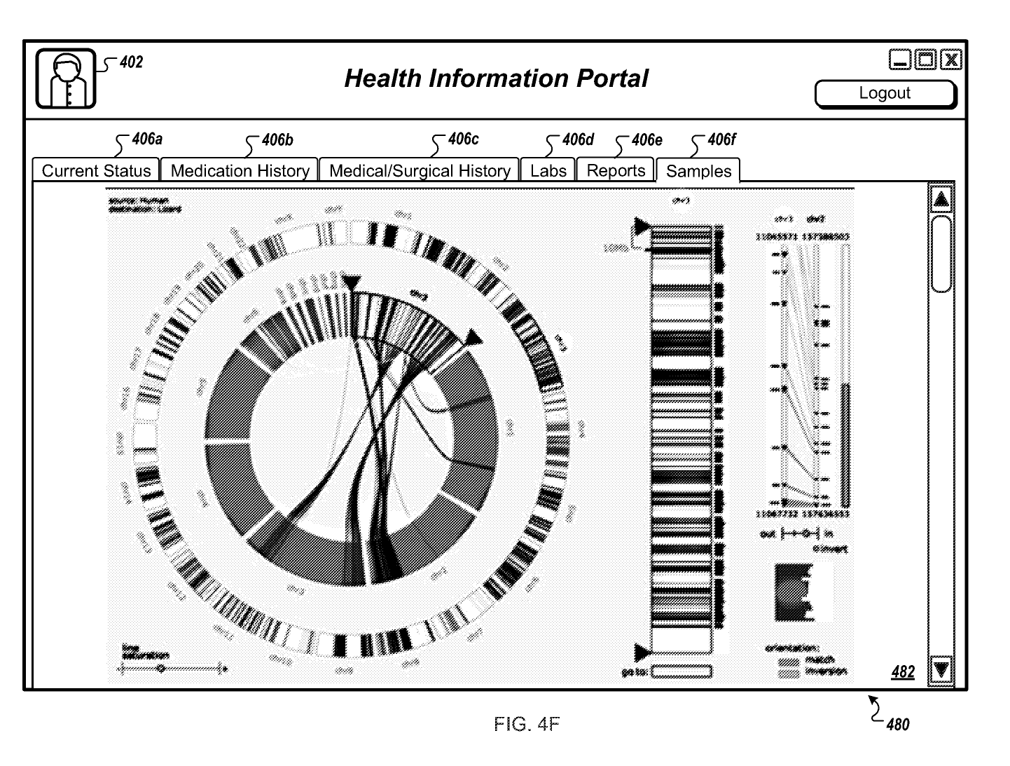

Turning to the main window 306, available reports 318 may be presented, such as an HIV 1.0 report 318a and an HIV 2.0 report 318b. In some implementations, selection of one of the available reports 318 may cause generation of a report review interface to review the results of analysis obtained through the execution of the associated genetic analysis application (e.g., favorite HIV 1.0 genetic analysis application 316a or favorite HIV 2.0 genetic analysis application 316b). An example of a report interface is illustrated in relation to FIG. 4E.

In some implementations, the reports may include clinical data associated with genetic analysis of genetic sequence data by an organization such as a research facility. As illustrated in FIG. 3A, for example, the HIV 1.0 report 318a is detailed as “Drug Resistance Reporting, FDA Approved, $135”. In some implementations, a particular research facility may pay a fee (e.g., $135) to review analysis derived by another organization.

In some implementations, selection of one of the reports 318 may result in the presentation of example analysis results which may be obtained through ordering genetic analysis using the associated genetic analysis application 316 (e.g., at the listed genetic analysis application price of $135 or $160, respectively). For example, in some implementations, example report data may provide a potential purchaser (e.g., individual, medical professional, research professional, etc.) with greater information regarding the detailed information available through purchase of a particular genetic analysis application.

Above the listed reports 318, a series of filters 320, including a “most recommended” filter 320a, a “newest” filter 320b, and an “all” filter 320c, in some implementations, may be used to quickly locate desired report information. As illustrated, the “most recommended” filter 320a may be presently selected, presenting the user “John Doe” with recommended reports (e.g., the reports obtained through the favorite genetic analysis applications 316). Selection of the “newest” filter 320b, in some implementations, may cause presentation of one or more reports generated more recently. In other implementations, selection of the “newest” filter 320b may result in presentation of report data associated with genetic analysis applications that were most recently added to the genetic analysis application system. Selection of the “all” filter 320c, in some implementations, may result in presentation of all of the reports generated through genetic analysis application orders issued by the user “John Doe”. In some implementations, selection of the “all” filter 320c may result in presentation of report data associated with all genetic analysis applications available through the genetic analysis application system.

Returning to the header bar 302, in some implementations, the information presented within the main window 306 may have been generated in response to selection of the “My Reports” control 312a. In some implementations, selection of the “My Reports” control 312a may result in a listing of all reports previously generated on behalf of the user “John Doe”.

Selection of the “My Orders” control 312b, in some implementations, may provide an order history, for example including one or more previously completed orders (e.g., resulting in report data available via the “My Reports” control 312a) as well as one or more in progress orders (e.g., recently ordered, where analysis is not yet complete). In some implementations, selection of the “My Orders” control 312b may provide the user “John Doe” with options regarding order history such as, in some examples, billing information, style of report data, or one or more recommended genetic analysis applications associated with one or more previously ordered genetic analysis applications.

In some implementations, selection of the “My Sequence” control 312c may result in generation of a user interface presenting one or more genetic sequence data structures associated with the user “John Doe”. In some implementations, the genetic sequence data may be presented as a graphical overview, for example to provide the user “John Doe” with a method of quickly reviewing and/or verifying uploaded genetic sequence data. In some implementations, a variety of meta data may be associated with the genetic sequence data such as, in some examples, a patient identifier, a sample date (e.g., date sample obtained, date sample sequenced, etc.), a sample type (e.g., human, canine, soybean, bacteria, virus, etc.), or a sample genetic material type (e.g., DNA, RNA, genomic, transcriptomic, etc.).

Turning to FIG. 3B, a screen shot 330 for an interface for placing orders for genetic analysis applications, in some implementations, may include a category presentation including the categories 314 (e.g., virology 314a, bacteriology 314b, oncology 314c, microbiology 314d, and pathology 314e) of genetic analysis applications presented along with various genetic analysis applications 334, 336, 338, 340, and 342, each set of genetic analysis applications 334, 336, 338, 340, and 342 associated with one of the categories 314. The category presentation illustrated by the screen shot 330, in some implementations, may be accessed through selection of the “all” filter 320c, as shown in FIG. 3A. In some implementations, the category presentation may be accessed through selection of the “Categories” control 314 in the side menu bar 304 of the screen shot 300 as described in relation to FIG. 3A.

At the top of the categories presentation, a set of filters 332 may include a “Clinical Diagnostics” filter 332a, a “Clinical Research” filter 332b, a “Research Use Only” filter 332c, and an “All” filter 332d. The set of filters 332, in some implementations, may represent a series of classifications associated with the genetic analysis applications 334, 336, 338, 340, and 342. The classifications, in some implementations, may be indicative of a level of detail available through report data generated by each of the associated genetic analysis applications 334, 336, 338, 340, and 342, and/or a level of acceptance in an associated industry (e.g., human medicine, veterinary medicine, etc.) of each of the associated genetic analysis applications 334, 336, 338, 340, and 342. For example, a classification of “Clinical Diagnostics” may be indicative of certification with a government and/or medical board. Genetic analysis applications classified as “Clinical Diagnostics”, in some implementations, may include analysis results useful in providing medical diagnosis to a patient. A cost associated with each of the genetic analysis applications 334, 336, 338, 340, and 342, in some implementations, may be reflective, in part, upon the classification of each of the genetic analysis applications 334, 336, 338, 340, and 342.

In some implementations, one or more of the genetic analysis applications 334, 336, 338, 340, and 342 may include a visual indication of classification. As illustrated in FIG. 3B, in some implementations, the genetic analysis applications 334a, 336a, 338a, 340a, and 342a may be shaded or color-coded (e.g., shaded with diagonal stripes) to indicate that the genetic analysis applications 334a, 336a, 338a, 340a, and 342a have a “Clinical Diagnostics” classification. Similarly, in some implementations, the genetic analysis applications 334b, 336b, 338b, 340b, and 342b may be shaded or color-coded (e.g., “white” or “solid color”) to indicate that the genetic analysis applications 334b, 336b, 338b, 340b, and 342b have a “Clinical Research” classification. Further to the example, in some implementations, the genetic analysis applications 334c, 336c, 338c, 340c, and 342c may be shaded or color-coded (e.g., shaded with hash marking) to indicate that the genetic analysis applications 334c, 336c, 338c, 340c, and 342c have a “Research Use Only” classification.

Selection of one of the filters 332, in some implementations, may result in regeneration of the presentation illustrated in the screen shot 330, for example including only those of the genetic analysis applications 334, 336, 338, 340, and 342 associated with the selected classification. For example, selection of the “Research Use Only” filter 332c, in some implementations, may result in the presentation of only genetic analysis applications 334c, 336c, 338c, 340c, and 342c (e.g., as shown in relation to each of the associated categories 314).

In some implementations, selection of one of the categories 314 may result in presentation of only those genetic analysis applications associated with the selected category. For example, selection of the microbiology category 314d may result in presentation of only genetic analysis applications 340a, 340b, and 340c. In some implementations, a user may further select one of the filters 332 to narrow the results to, for example, all genetic analysis applications in the microbiology category with a “Clinical Diagnostics” classification. Other interactions with the screen shot 330 are possible to obtain one or more desired genetic analysis applications 334, 336, 338, 340, and 342. Selection of one of the genetic analysis applications 334, 336, 338, 340, and 342, in some implementations, may result in presentation of a user interface for ordering the execution of the genetic analysis application against one or more sets of genetic sequence data.

Turning to FIG. 3C, a screen shot 350 for an interface for placing orders for genetic analysis applications, in some implementations, may include a progress report 354 regarding a genetic analysis application order 352. The progress report 354, in some implementations, may be presented upon selection of the “My Reports” control 312a, for example to provide a user with order information and an estimate for order conclusion.

The genetic analysis application order 352, in some implementations, may include brief overview information regarding an order, such as an order identification number (e.g., 101126FN-051) and a genetic analysis application title (e.g., HIV 1.0). In some implementations, the genetic analysis application order 352 may include information regarding the genetic sequence data applied to the order (e.g., “sample arrival date 02/10/2011”).

Turning to the progress report 354, information, in some implementations, may include an order number 356a (e.g., “125126FN-051” 356b) uniquely identifying an order such as, in some examples, a particular genetic analysis application, particular genetic analysis application applied to particular genetic sequence data, or a series of genetic analysis applications applied against one or more sets of genetic sequence data.

The information may further include, in some implementations, a service type 358a (e.g., “Value Service” 358b), for example representing a job priority. In some examples, the service type 358a may include one or more of a same day service (e.g., “Same Day”), a twenty-four hour service (e.g., “Rush”), a three day service (e.g., “Priority”), and a normal service (e.g., “Value”). The service priority, in some implementations, may be indicative, in some implementations, of a relation between the user “John Doe” and the genetic analysis application system or of a level of payment provided by the user “John Doe” (e.g., similar to priority shipment of goods).

Returning to the progress report 354, a service 360a (e.g., “New Diagnostic” 360b), in some implementations, may be indicative of the type of purchase made by the user “John Doe”. For example, “New Diagnostic” 360b may refer to the order 356a pertaining to a newly placed order. Other service indications, in some implementations, may include a “Recommended Diagnostic” (e.g., recommended in relation to a “New Diagnostic” upon analysis of the results), a “Repeat Screening” (e.g., in response to a fix made to a previously ordered genetic analysis application or responsive to obtaining an updated genetic sample), or a “Test Run” (e.g., in relation to a researcher testing a new genetic analysis application within the system environment).

The progress report 354 may, in some implementations, include a sample identifier 362a (e.g., “ABC678” 362b), for example uniquely identifying a sample being analyzed through the identified order 356a. In some implementations, the progress report 354 may list a sample type 364a (e.g., “Human Plasmid DNA” 364b) detailing a type of genetic material contained in the same that provided the genetic sequence data. In some examples, the sample type 364a may include one or more of DNA and RNA, either partial (e.g., obtained through PCR sequencing, etc.) or complete (e.g., genome or transcriptome). In further examples, the sample type 364a may indicate the source organism of the genetic sample, for example a human, animal, plant, virus, or bacteria.

Beneath the sample type 364a, the progress report 354 may include, in some implementations, a patient identifier 368a (e.g., “123XYZ” 368b). For example, in the circumstance of a medical or veterinarian patient, the patient identifier 368a may list a unique identifier associated with the source of the genetic sequence data. In other implementations, rather than listing the patient identifier 368a, the progress report 354 may include a source identifier (e.g., strain of genetically modified crop, batch of vaccine, etc.).

In some implementations, the progress report 354 may include an order status 370a (e.g., “Reviewing Sequence” 370b) that may provide a brief synopsis of the progress of the genetic analysis application order 352. In some examples, the order status 370a may include one of “Pending Scheduling”, “Analyzing”, “Generating Report Data”, or “Available for Review.”

The progress report 354, in some implementations, may include a delivery estimate 372a (e.g., “02/20/2011 13:45:00” 372b) providing an estimate of the availability of analysis results from the pending genetic analysis application order 352. In some implementations, the delivery estimate 372a may be updated on a periodic basis (e.g., every ten seconds, minute, three minutes, etc.) and/or at each stage of the order (e.g., as detailed by the order status 370a). As illustrated in FIG. 3C, the delivery estimate 372a includes both a date and a time. In other implementations, the delivery estimate 372a may include only a date, only a time, a range of dates, and/or a range of times.

The progress report 354, as illustrated in the screen shot 350, details “Basic Information.” In some implementations, more detailed information may be provided to the user “John Doe” such as, in some examples, a visual interface to review the genetic sequence data associated with the genetic analysis application order 352, sample report data associated with the genetic analysis application order 352, or instructions on interpretation of report data associated with the pending results of the genetic analysis application order 352. In some implementations, more detailed information may include a link to medical record information regarding the user “John Doe” or, if a separate individual, the patient identified using the patient identifier 368a.

Turning to FIGS. 4A through 4F, in some implementations, genetic analysis data gleaned from one or more genetic analysis applications may be combined with medical health records, for example in a health information portal. As illustrated in FIG. 4A, in some implementations, a health information portal may include access to medical record information pertaining to a patient, such as patient “John Doe” as illustrated in a header row image 402 and a side bar image 404 of a first screen shot 400. The patient, in some implementations, may access the health information portal by logging in using account information (e.g., user name and password, biometric information, etc.). As shown in the first screen shot 400, the patient, in some implementations, may have access to a variety of health-related information through a series of tabs 406 such as, in some examples, a “current status” tab 406a, a “medication history” tab 406b, a “medical/surgical history” tab 406c, and a “labs” tab 406d.

As illustrated, the “current status” tab 406a is active. In some implementations, upon gaining access to the health information portal, a user may be directed to the “current status” tab 406a, for example to review current health information. The current health information may include, in some implementations, a medical appointments reminder box 408, a current medications listing box 410, and a current lifestyle status box 412.

Turning to the current lifestyle status box 412, in some implementations, the patient “John Doe” may be presented with a series of status input controls 414, for example a pain level control 414a to provide an estimation of current pain level and an activity level control 414b to provide an estimation of a daily activity level. Other status input controls 414, in other implementations, are possible such as, for example, one or more symptom monitors for monitoring common symptoms associated with a condition being monitored (e.g., nausea, drowsiness, energy level, overall mood, etc.). In some implementations, information provided by the patient “John Doe” via the status input controls 414 may be made accessible to one or more professionals monitoring the health progress of the patient “John Doe” such as, in some examples, a physician, specialist, physical therapist, or rehabilitation coach. In some implementations, a health professional monitoring the health progress of the patient “John Doe” may input at least part of the information illustrated by the status input controls 414. In a particular example, the pain level control 414a and the activity level control 414b may be indicative of the progress of the patient “John Doe” during a daily rehabilitation session.

In some implementations, daily information submitted via the status input controls 414 may be analyzed to determine statistical trends and/or historic averages. The analysis, in some implementations, may result in triggering a recommendation for a particular test or treatment. For example, as illustrated in the medications listing box 410, the patient “John Doe” is currently taking Ibuprofen 418a. If, through data analysis, it is determined that an overall pain level is worsening, an alternative pain medication may be suggested. In some implementations, suggestions may be presented directly to the patient “John Doe”. The suggestions, in some implementations, may be provided to a professional who has access to the information provided by the patient “John Doe”.

As illustrated in the appointments reminder box 408, the patient “John Doe” has an upcoming appointment 416a with Dr. Jane Doe on August 31. In some implementations, prior to the appointment time, information collected through the health information portal may be supplied to Dr. Jane Doe to aid in the appointment. For example, a recommendation for a new pain medication may be provided to Dr. Jane Doe.

Turning to the medications listing box 410, each medication 418 currently taken by the patient “John Doe” may be listed, including, in some implementations, brief dosage instructions 420 and a consumer rating 422 associated with the medications 418. For example, the Ibuprofen 418a may be associated with instructions 420a of “Maximum daily dosage 3×800 mg” and a consumer rating 422a of three stars out of five. In some implementations, the consumer rating 422a may be indicative of a rating supplied by the patient “John Doe”. In other implementations, the consumer rating 422a may be indicative of an average consumer rating (e.g., via the health information portal or another source of prescription review) for the product Ibuprofen 418a.

In some implementations, the patient “John Doe” may select one of the medications 418 (e.g., Ibuprofen 418a or CardioHealth Daily 418b) to access additional information such as, in some implementations, usage, side effects, storage conditions, in case of overdose, and drug-drug interactions. For example, as indicated in the medications listing box 410 in relation to Ibuprofen 418a, an alert message 424a states that “There are 4 drug-drug interactions”. In some implementations, selection of Ibuprofen 418a and/or the alert message 424a may generate a greater level of detail for the patient “John Doe” regarding the drug-drug interactions.

Further information regarding medications, in some implementations, may be accessed through selection of the medication history tab 406b. Turning to FIG. 4B, in some implementations, the medication history tab 406b may provide access to detailed information regarding both medications currently prescribed for the patient “John Doe” (e.g., Ibuprofen 418a) as well as medications previously prescribed to patient “John Doe” that the patient “John Doe” has discontinued ingesting (e.g., rofecoxib 418c). As shown in FIG. 4B, each of the medications 418a, 418c, in some implementations, may be associated with one or more of dosage instructions 420a, 420c, consumer ratings 422a, 422c, a range of dates 432a, 432c (e.g., dates during which the patient “John Doe” was prescribed the associated medication 418a, 418c), a medication description 434a, 434c and a list of side effects 436.

In some implementations, the medication history, for example as provided in the medication history tab 406b, may be taken into consideration when recommending a new prescription, therapy, or treatment. For example, if the rating 422c may be indicative of the reaction “John Doe” had to the rofecoxib 418c when previously used, when determining a replacement pain killer for the Ibuprofen 418a, the rofecoxib 418c and any associated (e.g., brand name, combination, etc.) drugs may be avoided or given deferential treatment.

Turning to FIG. 4C, as illustrated in a screen shot 440, upon selection of the medical/surgery history tab 406c, in some implementations, information regarding one or more operations (e.g., surgeries, skin grafts, transplants, etc.) and/or out patient procedures (e.g., vasectomy, laser vision correction, biopsies, etc.) may be presented. In some implementations, medical record information such as medical images (e.g., x-ray, magnetic resonance imaging (MRI), magnetic resonance tomography (MRT), computed tomography (CT), computed axial tomography (CAT), etc.), surgical statistics (e.g., blood levels, heart rate, reaction to anesthesia, etc.), and recovery data (e.g., progress reports, success prognosis, etc.) may be made available through selection of one or more procedures provided within a presentation. As illustrated, in some implementations, each procedure may be presented using an image 442 (e.g., medical image, icon indicating type of procedure, etc.), a title 444, and a timestamp 446 (e.g., date, time and date, date range, etc.). As illustrated, patient “John Doe” has undergone surgeries involving a “Saggital View of Right Kidney” 444a, a “2D Steer—ICA Plaque” 444b, and a “Transverse View—Fetal Liver-Lung” 444c.

Turning to FIG. 4D, upon selection of the Labs tab 406d, in some implementations, the user “John Doe” may be presented with a list of laboratory work including results of laboratory analysis, as shown in a screen shot 450. Laboratory analysis, in some examples, may include one or more of blood analysis, urine analysis, heart monitoring (e.g., blood pressure, electrocardiogram, echocardiogram, etc.), bone density screening, infertility screening, and/or genetic analysis of biologic samples. In some implementations, a series of laboratory results 454 may be presented to the user, for example within a timeline format upon selection of a “view results by report” control 452b or by laboratory category (e.g., blood, urine, heart, genetic, etc.) upon selection of a “view results by category” control 452a.

Each of the laboratory results 454, in some implementations, may include a general indication of results of the test 460 (e.g., a check mark 460a, 460c for results within a desired range, an alert 460b for results outside the desired range, etc.), a listing of one or more items 462 tested, conditions and/or indications 464, and a graphical result indicator 466 illustrating a position of patient results in relation to a result range.

As illustrated in the screen shot 450, associated with each laboratory work (e.g., as evidenced by a date 456a, 456b) is one or more laboratory results 454. To access detailed results regarding each laboratory work, in some implementations, a user may select a view report control 458a, 458b.

In some implementations, selection of the view report control 458a may cause the generation of a screen shot 470 as illustrated in FIG. 4E. As shown in the screen shot 470, a reports tab 406e may be selected, providing information regarding a particular report 472 (e.g., the “HIV-1 Genotyping Test: Resistance Report”). The report 472 may include, in some implementations, a set of report information 474, a set of requester information 476, and one or more data reporting sections 478.

Turning to the report information 474, in some implementations, the user may be presented with a series of information regarding genetic sequencing analysis via a genetic analysis application such as, in some examples, a sample identifier “ABC678” 474a, a patient identifier “123XYZ”, a patient name “John Doe”, a date drawn “02/10/2011” and a report date “02/20/2011”. In some implementations, the report information 474 may correspond in part to information presented to a user in relation to the order of a genetic analysis application, such as information contained in the progress report 354 illustrated in the screen shot 350 of FIG. 3C.

Returning to FIG. 4E, positioned next to the report information 474, as illustrated in the screen shot 470, the requester information 476, in some implementations, may include information regarding the requester of the report 472. The requester information 476, in some examples, may include a physician name, an institution name, a telephone number, and a facsimile number.

Beneath the report information 474 and the requester information 476, in some implementations, the data reporting sections 478a and 478b may provide detailed information regarding the results of the genetic analysis done on the sample “ABC678” 474a. As illustrated, the data reporting sections 478a and 478b may contain textual report information detailing a resistance interpretation associated with various gene mutations. In some implementations, graphical analysis may be presented regarding the patient “John Doe”, for example comparing results of the analysis to a standard range or illustrating estimated drug compatibilities for treatment of HIV based upon the analysis obtained from the sample “ABC678” 474a. Although illustrated as a report presented within a tab of the health information portal, in some implementations report data may be presented within a separate user interface or provided in a downloadable file for local viewing. The report 472, in some implementations, may include controls for requesting guidance in interpreting results or links for obtaining more information regarding the results presented.

Turning to FIG. 4F, upon selection of the sample “ABC678” 474a from within the report information 474 of FIG. 4E, in some implementations, a visual representation of genetic sequence data 482 may be presented in a samples tab 406f of the health information portal. The graphical display may illustrate various areas of potential clinical interest as well as, in some implementations, segments of DNA sequence which are either similar to or in some way differentiated from a standard. The visual representation of the genetic sequence data 482, in some implementations, may enable a user interacting with the graphical display to zoom into areas of interest or to easily recognize genetically unique segments of the genetic sequence data displayed.

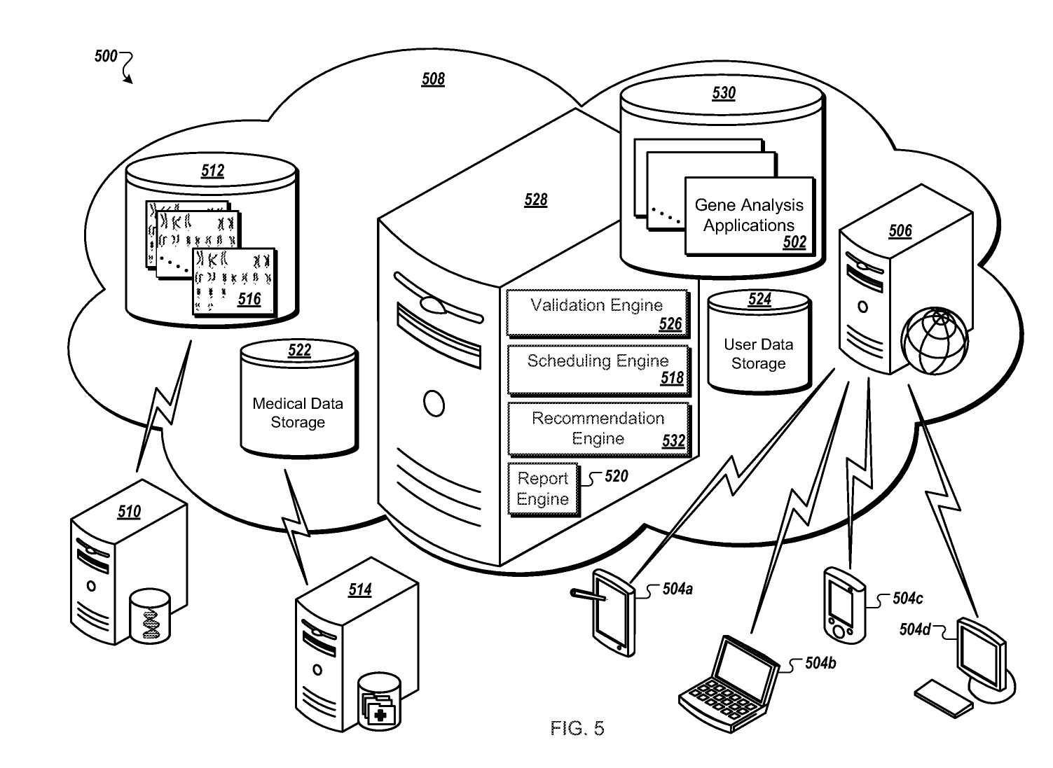

Turning now to FIG. 5, in some implementations, a network environment 500 for genetic analysis of genetic sequence data 516 using a variety of genetic analysis applications 502 may include a number of user devices 504 communicating with one or more web servers 506 in a cloud computing environment 508. In some implementations, the cloud computing environment 508 may include one or more provisioning servers 528 for coordinating the execution of genetic analysis using the set of genetic analysis applications 502 as well as one or more storage mediums 530 storing genetic analysis applications 502 and associated meta data. The cloud computing environment 508, in some implementations, may be provisioned for receiving a request for execution of one or more of the genetic analysis applications 502 against one or more sets of genetic sequence data 516. In some implementations, the request may be issued from one of the user devices 504. In response to the request, in some implementations, the cloud computing environment 508 may schedule the execution of the selected applications 502 using a scheduling engine 518, and provide the results of the genetic analysis to one or more of the user devices 504, for example as report data generated by a report engine 520.

The cloud computing environment 508, in some implementations, may upload the genetic sequence data 516 from one or more genetic sequencing servers 510 (e.g., genetic sequencing facility, hospital sequencing unit, physician office sequencing unit, laboratory sequencing unit, or corporate sequencing unit, etc.) and store the genetic sequence data 516 in a genetic sequence data storage medium 512 (e.g., one or more storage devices each including a non-transitory computer readable medium). The genetic sequence data storage medium 512, in some implementations, may be used to store the genetic sequence data 516 for the duration of analysis (e.g., the request for execution of one or more genetic analysis applications 502). In other implementations, the genetic sequence data 516 may be maintained within the genetic sequence data storage medium 512 for a period of time, allowing a user to request additional genetic analysis applications 502 associated with the previous uploaded genetic sequence data 516 without causing another upload of the genetic sequence data 516. In some implementations, a user may pay a fee for storing genetic sequence data 516 beyond the duration of the analysis period. Storage of the genetic sequence data 516, in some implementations, may time out based upon a projected “shelf life” of the information. For example, an RNA sample of viral biologic material may have a shorter shelf life, while a genome analysis of human DNA may have a longer shelf life.

Each genetic sequence data 516 in the genetic sequence data storage medium 512, in some implementations, may be associated with meta data such as, in some examples, a unique sample identifier, a unique patient identifier, an upload facility identifier, a sample type, a sequencing type, and patient demographics. In some implementations, a portion of the genetic sequence data 516 may be available for performing tests against new genetic analysis applications 502. For example, based upon meta data information associated with each genetic sequence data 516, a portion of the genetic sequence data 516 may be selected for analysis as test data. In some implementations, the genetic sequence data 516 used for testing purposes may be logically or physically separate from genetic sequence data 516 used for paid analysis. For example, a number of test sequences may be uploaded by a research facility for genetic analysis application testing purposes.

In some implementations, a medical record server 514 may provide additional meta data regarding one or more of the sets of genetic sequence data 516 stored within the genetic sequence data storage medium 512. The medical record server 514, in some implementations, may be provided as part of the cloud computing environment 508 (not illustrated) or medical data may be uploaded from the medical record server 514 (e.g., one or more medical record access servers such as an insurance company server, hospital server, physician's office server, etc.) into the cloud computing environment 508 to be stored, for example, in a medical data storage 522 (e.g., one or more data storage devices including non-transitory storage mediums).

In some implementations, demographic information, medical history information, and/or previous report data, as derived from medical history records stored within the medical data storage 522, may be correlated with genetic sequence data 516 stored within the genetic sequence data storage medium 512. In some implementations, statistical data may be culled from the medical record data in the medical data storage 522. In some examples, a research organization or medical insurance company may retrieve statistical demographic data regarding a population of patients who have received genetic analysis using a particular genetic analysis application 502 or a particular set of genetic analysis applications 502 (e.g., all genetic analysis applications certified to screen for HIV, etc.).

A user, in some implementations, may request genetic analysis of one or more sets of genetic sequence data 516 (e.g., stored in the genetic sequence data storage medium 512 or available for upload to the genetic sequence data storage medium 512) through selection of one or more of the genetic analysis applications 502. The genetic analysis applications 502, in some implementations, may include applications focused in a variety of categories (e.g., virology, bacteriology, oncology, microbiology, pathology, etc.). In some implementations, the genetic analysis applications 502 may be classified into two or more classifications, for example based upon level of certification, type of report data generated, and/or utility of the report data generated. In some implementations, a user may be provided with a graphical user interface for selection of one or more genetic analysis applications 502. In other implementations, the request for genetic analysis through one or more genetic analysis applications 502 may be placed through a non-real-time request to the cloud computing environment 508. In some examples, a non-real-time request may be placed in the form of an email, telephone call, facsimile, or paper-based postal request.

In some implementations, the media server 506 may provide a user interface, such as a web page, web portal, or shared interface application for selection and ordering of genetic analysis applications 502. For example, a user may log into an account with the cloud computing environment 508 (e.g., as determined based upon user data accessed from a user data storage 524) to review existing data (e.g., report data, genetic sequence data, etc.) or to create new genetic analysis application requests through an interactive user interface provided by the media server 506. In some implementations, the media server 506 may include two or more servers, for example geographically provisioned or otherwise made available to serve interfaces to a variety of users accessing the cloud computing environment 508 through a variety of user devices 504.

The media server 506, in some implementations, may vary the type of interactive user interface based, in part, upon a type of the user device 504 accessing the cloud computing environment 508. For example, an interactive user interface destined for rendering upon a laptop computer device 504b or computing station 504d (e.g., terminal within a hospital, physician's office, or other medical facility, computer in a university research laboratory, etc.) may include a different presentation than an interactive user interface destined for a smart phone device 504c or a tablet computer 504a. In some implementations, the interactive user interface may be generated based in part upon a type of user (e.g., as determined from user data stored in the user data storage 524). For example, a user interface created on behalf of an individual may contain a different presentation of information than a user interface created on behalf of a physician or medical facility. In some implementations, the interactive user interface may be generated based in part upon user permissions (e.g., as determined from user data stored in the user data storage 524). For example, a subset of the genetic analysis applications 502 may be available only to a select group of users based on, in some examples, medical affiliation, organization affiliation, or personal or organizational accreditation.

Upon receipt of the request for genetic analysis, in some implementations, the cloud computing environment 508 may coordinate the validation of one or more sets of genetic sequence data 516 associated with the request, for example using a validation engine 526. In some examples, genetic sequence data 516 may be verified for compatible type (e.g., DNA, RNA, etc.), compatible source (e.g., human, animal, plant, viral, bacterial, etc.), or compatible sample date (e.g., for viral, bacterial, and/or RNA).

The cloud computing environment 508 may schedule genetic analysis of the genetic sequence data 516 associated with the request using the scheduling engine 518. In some implementations, the scheduling engine 518 may schedule execution of the request across one or more processors or one or more servers. In some implementations, the scheduling engine 518 may schedule two or more genetic analysis applications 502 identified within a single request to execute concurrently, for example if using different genetic sequence data 516, different portions of the same genetic sequence data 516, or if at least two of the two or more genetic analysis applications 502 identified within the request do not require analysis results from one another. In some implementations, the scheduling engine 518 may schedule two or more genetic analysis applications 502 identified within a single request to execute in series, for example if one of the genetic analysis applications 502 is reliant upon data derived by another of the genetic analysis applications 502.

A recommendation engine 532, in some implementations, may identify one or more additional genetic analysis applications 502 pertinent to the results of the analysis achieved by the requested genetic analysis applications 502. The recommendation engine 532, for example, may receive a portion of the results of analysis and, based upon the results, identify one or more follow-up genetic analysis applications 502 to recommend to the requester. In some implementations, the recommendation engine 532 may analyze results obtained from execution of one or more genetic analysis applications 502 against a portion of the medical data associated with the genetic sequence data 516 provided in relation to the genetic analysis request to determine one or more additional recommended genetic analysis applications 502. In some examples, the medical data may refer to the source of the genetic sequence data 516, a relative, a potential mate, or a potential organ donor or other biological material donor.

The recommendation engine 532, in some implementations, may provide the recommendation to the report engine 520 to be combined with report data regarding genetic analysis results. In other implementations, the recommendation engine 532 may provide the recommendation to the media server 506 for presentation to one or more of the user devices 504. In further implementations, the recommendation engine 532 may provide the recommendation to the requester using contact information retrieved from user data storage 524 (e.g., telephone number, facsimile number, mailing address, email address, etc.).

In some implementations, the recommendation engine 532 may provide a recommendation some time in the future based upon new information available within the cloud computing environment 508. For example, if a new genetic analysis application 502 is added to the cloud computing environment 508 which is relevant to a previously run genetic analysis application 502, the recommendation engine 532 may alert the requester regarding the new genetic analysis application 502. Similarly, if an error is determined in a previously run genetic analysis application 502 or if a richer detailed version of analysis or reporting associated with a previously executed genetic analysis application 502 becomes available, in some implementations, the recommendation engine 532 may alert a requester regarding the updated version of the previously requested genetic analysis application 502.

In some implementations, execution of a particular genetic analysis application 502 may include generating report data regarding the results of the analysis, for example using the report engine 520. The report data, in some implementations, can include one or more of identifying information identifying, in some examples, the sample, patient, requester, facility, and/or genetic analysis application. In some implementations, the report data may include one or more of textual results, charts, graphs, graphical correspondence to a range of anticipated results, and graphical correspondence to a range of desired or “normal” results. In some implementations, the report data may include information regarding the topic of the genetic analysis application (e.g., a particular disease, condition, genetic predilection, etc.) and/or information directing a requestor to additional help in interpreting the data presented in the report. In some implementations, report data may be generated for consumption based in part upon a type of user device. For example, report data destined for the laptop computer device 504b or the computing station 504d may include a different presentation than report data destined for the smart phone device 504c or the tablet computer 504a. In some implementations, report data may be generated for consumption based in part upon a type of user. For example, a report created on behalf of an individual may contain a different presentation of information than a report created on behalf of a physician or medical facility.

In some implementations, report data may be provided to one or more of the user devices 504 via the media server 506. In some implementations, report data may be presented in an interactive interpretation interface, for example including help in interpreting data contained within the report and/or controls to access further information regarding data provided within the report.

In some implementations, the media server 506 may provide report data through a medical information portal containing information both on genetic analysis applications 502 provided by the cloud computing environment 508 and on medical data retrieved from the medical data server 514 (e.g., as stored in the medical data storage 522). The medical information portal, in some implementations, may include features for social interaction between groups of users. For example, users may have the ability to rate or promote one or more genetic analysis applications 502, therapies, treatments, and/or drugs via social networking features of the medical information portal. In some implementations, the social networking features may include virtual support groups for patients and/or medical professionals dealing with a particular disease, condition, or other medical issue.

In some implementations, the media server 506 may provide report data through a research collaboration portal containing information both on genetic analysis applications 502 provided by the cloud computing environment 500 and on additional research data, for example obtained through a research data server (not illustrated). In some implementations, the research data may include one or more of reports, white papers, or presentations (e.g., video, audio, multimedia, etc.) regarding one or more genetic analysis applications created by a research facility. In some implementations, one or more research facilities may share genetic sequencing test data, collaborate on analysis of test results, or discuss ideas on further genetic analysis applications via the research collaboration portal. The research collaboration portal, in some implementations, may include social networking features, for example allowing researchers to create groups for discussing developments within a particular field or related to a particular type of genetic analysis application.

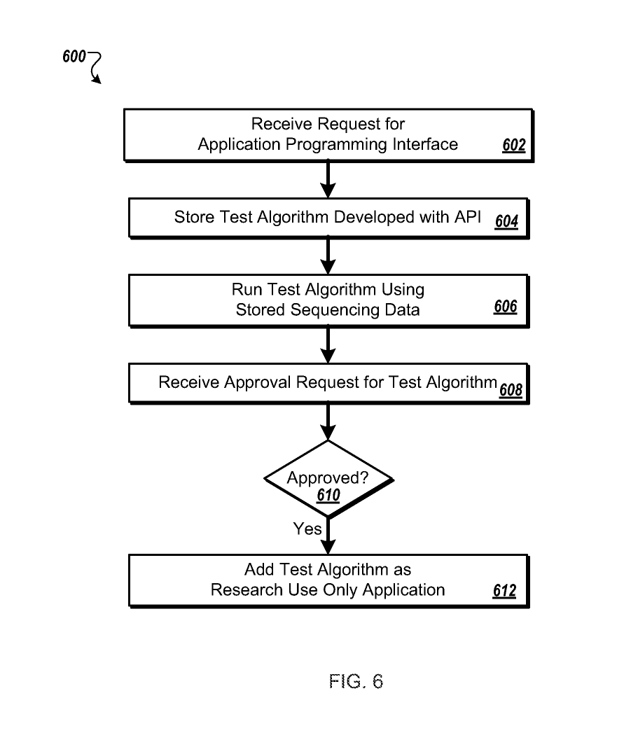

Turning to FIG. 6, a flow chart of an example method 600 for adding a new genetic analysis application to a system for analysis of genetic sequence data, in some implementations, may begin with receiving a request for an application programming interface (API) (602). The API, in some implementations, may include a series of tools for creating a new application for genetic analysis to be used in a system for obtaining genetic analysis of genetic sequence data. The API, in some implementations, may allow a test algorithm coder to build, compile and debug an algorithm for analyzing genetic sequence data. In some implementations, the API may be provided to a variety of hospitals, universities, and other research organizations affiliated with the system for obtaining genetic analysis of genetic sequence data. In some implementations, the API may be downloaded to a local computing environment for development purposes. In some implementations, a portion of the API may be executed by a remote server, for example in a cloud computing environment.

In some implementations, the API may allow a developer to collaborate on the design of the test algorithm with other developers within the cloud computing environment, for example through one or more social networking and collaboration tools. The developer of the test algorithm, for example, may have the option to invite one or more collaborators to share in the development of the test algorithm. In some implementations, developers having similar user rights within the cloud computing environment (e.g., members of a same group such as a same organization, university, lab environment, etc.) may automatically share access to the development of the test algorithm.

In some implementations, the test algorithm may take the form of a genetic analysis application for analysis of all or a portion of one or more of DNA and RNA. In some implementations, the test algorithm may be created to obtain information in a particular category of genetic analysis such as, in some examples, virology, bacteriology, oncology, microbiology, or pathology. The test algorithm, in some implementations, may be designed to identify genetic information suspected to be relevant to a particular condition or disease.

In some implementations, a test algorithm developed using the API may be stored (604). The test algorithm, in some implementations, may be stored as a genetic analysis application within a network environment for genetic analysis of genetic sequence data. The test algorithm, in some implementations, may be uploaded to the network environment through a secure network communication channel In some implementations, the developer may mail or deliver code containing the test algorithm to a facility for uploading of the test algorithm.

In some implementations, an administrator of the network environment for genetic analysis of genetic sequence data may validate the test algorithm prior to introducing the test algorithm to the genetic analysis application system. For example, the administrator may verify that the test algorithm will not harm the computing environment (e.g., crash, take up too many resources, fail to release resources, etc.) prior to introducing the test algorithm to the genetic analysis application system.

In addition to the test algorithm, in some implementations, one or more sets of genetic sequence data may be stored for test purposes. The genetic sequence data, in some implementations, may be dummy data created specifically to test the efficacy of the test algorithm.

In some implementations, a test algorithm may be run using stored sequencing data (606). The test algorithm, in some implementations, may be executed within a genetic analysis application system against one or more sets of genetic sequence data. In some implementations, the genetic sequence data may include test data or “dummy” (e.g., derived rather than sequenced from a particular organism) data. In some implementations, the genetic sequence data may include anonymous genetic sequence data. In some implementations, a user of the genetic analysis system may offer genetic sequence data for research purposes. The user, for example, may receive benefit from offering sequencing data for test purposes, such as free storage of the genetic sequence data for a prolonged period of time or a discount on analysis of the genetic sequence data using one or more genetic analysis applications.

In some implementations, a request for approval of the test algorithm may be received (608). Once the test algorithm is believed to be operational, in some implementations, a developer may request approval of the test algorithm. In some implementations, one or more administrators of the genetic analysis application system may review the test algorithm for approval. Approval of the test algorithm may involve, in some examples, validation of functionality within the genetic analysis application system, validation of results output, and review of supporting research as to the basis for the genetic analysis performed by the test algorithm. In some implementations, approval of the test algorithm may include setting a fee associated with the execution of the test algorithm as a genetic analysis application.

If the test algorithm is approved (610), in some implementations, the test algorithm may be added as a new genetic analysis application (612). In some implementations, the new genetic analysis application may be classified as a “Research Use Only” application. The new genetic analysis application, in some implementations, may be made available to other users of the genetic analysis application system. For example, upon access to the system, a user may be presented with the option of selecting the new genetic analysis application for execution against genetic sequence data. If a fee is associated with the new genetic analysis application, in some implementations, the user may be charged a fee for execution of the new genetic analysis application.

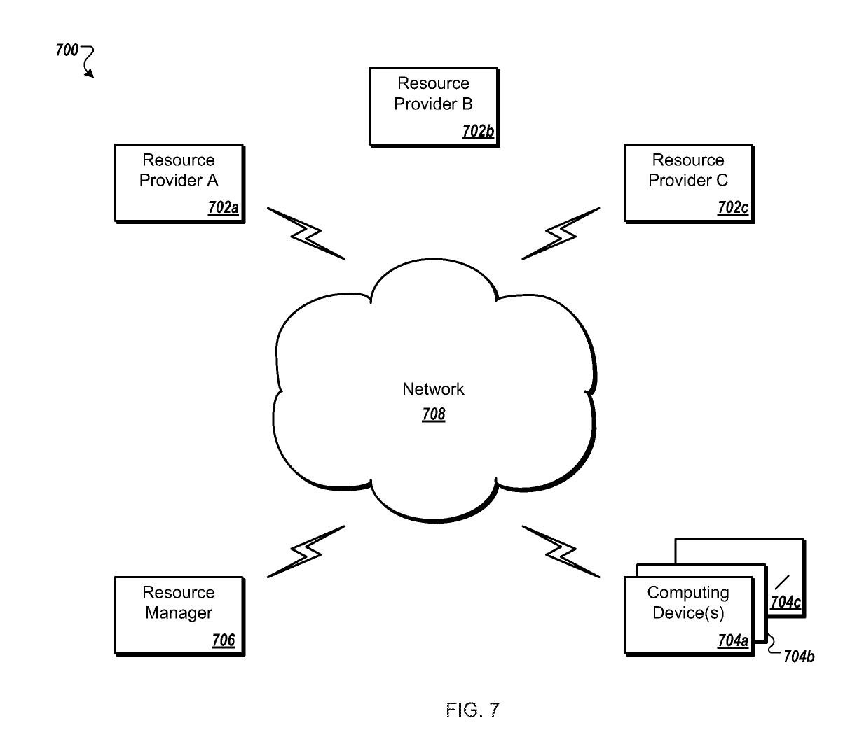

As shown in FIG. 7, an implementation of an exemplary cloud computing environment 700 for analysis of genetic sequence data is shown and described. The cloud computing environment 700 may include one or more resource providers 702a, 702b, 702c (collectively, 702). Each resource provider 702 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 702 may be connected to any other resource provider 702 in the cloud computing environment 700. In some implementations, the resource providers 702 may be connected over a computer network 708. Each resource provider 702 may be connected to one or more computing device 704a, 704b, 704c (collectively, 704), over the computer network 708.

The cloud computing environment 700 may include a resource manager 706. The resource manager 706 may be connected to the resource providers 702 and the computing devices 704 over the computer network 708. In some implementations, the resource manager 706 may facilitate the provision of computing resources by one or more resource providers 702 to one or more computing devices 704. The resource manager 706 may receive a request for a computing resource from a particular computing device 704. The resource manager 706 may identify one or more resource providers 702 capable of providing the computing resource requested by the computing device 704. The resource manager 706 may select a resource provider 702 to provide the computing resource. The resource manager 706 may facilitate a connection between the resource provider 702 and a particular computing device 704. In some implementations, the resource manager 706 may establish a connection between a particular resource provider 702 and a particular computing device 704. In some implementations, the resource manager 706 may redirect a particular computing device 704 to a particular resource provider 702 with the requested computing resource.

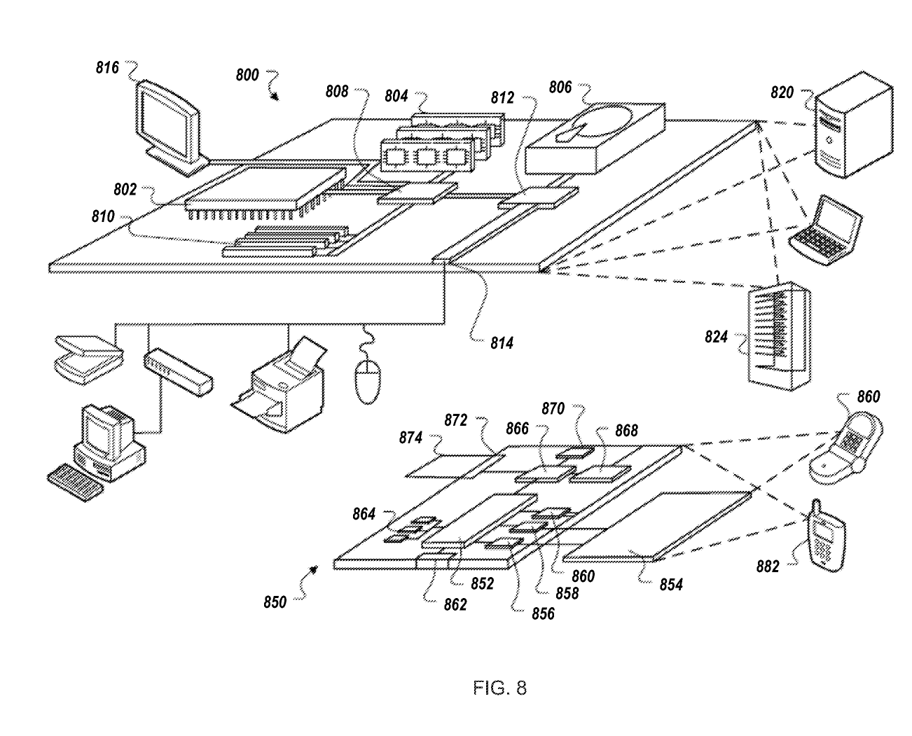

FIG. 8 shows an example of a computing device 800 and a mobile computing device 850 that can be used to implement the techniques described in this disclosure. The computing device 800 is intended to represent various forms of digital computers, such as laptops, desktops, workstations, personal digital assistants, servers, blade servers, mainframes, and other appropriate computers. The mobile computing device 850 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 800 includes a processor 802, a memory 804, a storage device 806, a high-speed interface 808 connecting to the memory 804 and multiple high-speed expansion ports 810, and a low-speed interface 812 connecting to a low-speed expansion port 814 and the storage device 806. Each of the processor 802, the memory 804, the storage device 806, the high-speed interface 808, the high-speed expansion ports 810, and the low-speed interface 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as a display 816 coupled to the high-speed interface 808. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 804 stores information within the computing device 800. In some implementations, the memory 804 is a volatile memory unit or units. In some implementations, the memory 804 is a non-volatile memory unit or units. The memory 804 may also be another form of computer-readable medium, such as a magnetic or optical disk.

The storage device 806 is capable of providing mass storage for the computing device 800. In some implementations, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 802), perform one or more methods, such as those described above. The instructions can also be stored by one or more storage devices such as computer- or machine-readable mediums (for example, the memory 804, the storage device 806, or memory on the processor 802).

The high-speed interface 808 manages bandwidth-intensive operations for the computing device 800, while the low-speed interface 812 manages lower bandwidth-intensive operations. Such allocation of functions is an example only. In some implementations, the high-speed interface 808 is coupled to the memory 804, the display 816 (e.g., through a graphics processor or accelerator), and to the high-speed expansion ports 810, which may accept various expansion cards (not shown). In the implementation, the low-speed interface 812 is coupled to the storage device 806 and the low-speed expansion port 814. The low-speed expansion port 814, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. In addition, it may be implemented in a personal computer such as a laptop computer 822. It may also be implemented as part of a rack server system 824. Alternatively, components from the computing device 800 may be combined with other components in a mobile device (not shown), such as a mobile computing device 850. Each of such devices may contain one or more of the computing device 800 and the mobile computing device 850, and an entire system may be made up of multiple computing devices communicating with each other.

The mobile computing device 850 includes a processor 852, a memory 864, an input/output device such as a display 854, a communication interface 866, and a transceiver 868, among other components. The mobile computing device 850 may also be provided with a storage device, such as a micro-drive or other device, to provide additional storage. Each of the processor 852, the memory 864, the display 854, the communication interface 866, and the transceiver 868, are interconnected using various buses, and several of the components may be mounted on a common motherboard or in other manners as appropriate.

The processor 852 can execute instructions within the mobile computing device 850, including instructions stored in the memory 864. The processor 852 may be implemented as a chipset of chips that include separate and multiple analog and digital processors. The processor 852 may provide, for example, for coordination of the other components of the mobile computing device 850, such as control of user interfaces, applications run by the mobile computing device 850, and wireless communication by the mobile computing device 850.

The processor 852 may communicate with a user through a control interface 858 and a display interface 856 coupled to the display 854. The display 854 may be, for example, a TFT (Thin-Film-Transistor Liquid Crystal Display) display or an OLED (Organic Light Emitting Diode) display, or other appropriate display technology. The display interface 856 may include appropriate circuitry for driving the display 854 to present graphical and other information to a user. The control interface 858 may receive commands from a user and convert them for submission to the processor 852. In addition, an external interface 862 may provide communication with the processor 852, so as to enable near area communication of the mobile computing device 850 with other devices. The external interface 862 may provide, for example, for wired communication in some implementations, or for wireless communication in other implementations, and multiple interfaces may also be used.

The memory 864 stores information within the mobile computing device 850. The memory 864 can be implemented as one or more of a computer-readable medium or media, a volatile memory unit or units, or a non-volatile memory unit or units. An expansion memory 874 may also be provided and connected to the mobile computing device 850 through an expansion interface 872, which may include, for example, a SIMM (Single In Line Memory Module) card interface. The expansion memory 874 may provide extra storage space for the mobile computing device 850, or may also store applications or other information for the mobile computing device 850. Specifically, the expansion memory 874 may include instructions to carry out or supplement the processes described above, and may include secure information also. Thus, for example, the expansion memory 874 may be provide as a security module for the mobile computing device 850, and may be programmed with instructions that permit secure use of the mobile computing device 850. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier. that the instructions, when executed by one or more processing devices (for example, processor 852), perform one or more methods, such as those described above. The instructions can also be stored by one or more storage devices, such as one or more computer- or machine-readable mediums (for example, the memory 864, the expansion memory 874, or memory on the processor 852). In some implementations, the instructions can be received in a propagated signal, for example, over the transceiver 868 or the external interface 862.

The mobile computing device 850 may communicate wirelessly through the communication interface 866, which may include digital signal processing circuitry where necessary. The communication interface 866 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 868 using a radio-frequency. In addition, short-range communication may occur, such as using a Bluetooth®, Wi-Fi™, or other such transceiver (not shown). In addition, a GPS (Global Positioning System) receiver module 870 may provide additional navigation- and location-related wireless data to the mobile computing device 850, which may be used as appropriate by applications running on the mobile computing device 850.

The mobile computing device 850 may also communicate audibly using an audio codec 860, which may receive spoken information from a user and convert it to usable digital information. The audio codec 860 may likewise generate audible sound for a user, such as through a speaker, e.g., in a handset of the mobile computing device 850. Such sound may include sound from voice telephone calls, may include recorded sound (e.g., voice messages, music files, etc.) and may also include sound generated by applications operating on the mobile computing device 850.

The mobile computing device 850 may be implemented in a number of different forms, as shown in the figure. For example, it may be implemented as a cellular telephone 880. It may also be implemented as part of a smart-phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for analysis of genetic sequence data are provided. Having described certain implementations of methods and apparatus for supporting analysis of genetic sequence data, it will now become apparent to one of skill in the art that other implementations incorporating the concepts of the disclosure may be used.

Therefore, the disclosure should not be limited to certain implementations, but rather should be limited only by the spirit and scope of the following claims.

What is claimed:

1. A method comprising:
receiving an indication of selection of a first diagnostic algorithm of a plurality of diagnostic algorithms for analyzing genetic sequence data, wherein the indication is associated with an identifier;
retrieving, from a storage medium, first genetic sequencing data associated with the identifier; and
analyzing, by one or more processors, the first genetic sequencing data using the first diagnostic algorithm to obtain at least one diagnostic result.

2. The method of claim 1, wherein the one or more processors comprise a plurality of networked processors.

3. The method of claim 2, wherein the plurality of networked processors are distributed in a cloud network environment in communication with a remote computing device, the method further comprising:
providing the at least one diagnostic result to the remote computing device.

4. The method of claim 1, wherein the first genetic sequencing data comprises genome data.

5. The method of claim 1, wherein the first genetic sequencing data comprises transcriptome data.

6. The method of claim 1, wherein the first genetic sequencing data comprises data derived from at least one of a human, animal, plant, viral, or bacterial biologic sample.

7. The method of claim 1, wherein the at least one diagnostic result comprises at least one of (a) resistance patterns, (b) a respiratory panel, and (c) a transplantation panel.

8. The method of claim 1, further comprising:
determining a change in diagnosis practices relevant to the first diagnostic algorithm of the plurality of diagnostic algorithms; and
providing an alert associated with the identifier, wherein the alert comprises a recommendation for a new diagnostic algorithm of the plurality of diagnostic algorithms.

9. The method of claim 1, wherein:
each respective diagnostic algorithm of the plurality of diagnostic algorithms is associated with at least one category of a plurality of categories, and
the plurality of categories comprises one or more of virology, bacteriology, oncology, microbiology, and pathology.

10. The method of claim 9, further comprising:
generating, for presentation at a user device, interface information comprising a plurality of controls corresponding to the plurality of diagnostic algorithms, wherein
each respective control of the plurality of controls is associated with a respective diagnostic algorithm of the plurality of diagnostic algorithms,
generating the interface information comprises associating each respective control of the plurality of controls with a respective visual indication corresponding to at least one category of the plurality of categories, and
receiving the indication of selection of the first diagnostic algorithm comprises receiving the indication of selection of a first control of the plurality of controls from the user device, wherein the first control corresponds to the first diagnostic algorithm.

11. The method of claim 10, wherein associating each respective control of the plurality of controls with the respective visual indication comprises spatially organizing the plurality of controls into a plurality of groups, wherein each group of the plurality of groups corresponds to a respective category of the plurality of categories.

12. The method of claim 1, wherein:
the first diagnostic algorithm of the plurality of diagnostic algorithms is associated with at least one classification of a plurality of classifications, and
the plurality of classifications comprise one or more of research use, clinical study, certified, clinical diagnosis, and federal drug administration (FDA) approved.

13. The method of claim 12, wherein:
each respective diagnostic algorithm of the plurality of diagnostic algorithms is associated with a respective price, and
the price is based in part upon the respective classification of the plurality of classifications.

14. The method of claim 12, further comprising:
generating, for presentation at a user device, interface information comprising a plurality of controls corresponding to the plurality of diagnostic algorithms, wherein
each respective control of the plurality of controls is associated with a respective diagnostic algorithm of the plurality of diagnostic algorithms,
generating the interface information comprises associating each respective control of the plurality of controls with a respective visual indication corresponding to at least one classification of the plurality of classifications, and
receiving the indication of selection of the first diagnostic algorithm comprises receiving the indication of selection of a first control of the plurality of controls from the user device, wherein the first control corresponds to the first diagnostic algorithm.

15. The method of claim 14, wherein:
associating each respective control of the plurality of controls with the respective visual indication comprises spatially organizing the plurality of controls into a plurality of groups, and
each group of the plurality of groups corresponds to a respective classification of the plurality of classifications.

16. The method of claim 1, further comprising:
generating report data comprising the at least one diagnostic result, wherein
generating the report data comprises formatting the report data for review by a user.

17. The method of claim 16, further comprising:
retrieving, from a second storage medium, medical record data, wherein the report data comprises a portion of the medical record data.

18. The method of claim 16, wherein:
the identifier is associated with a set of meta data comprising demographic information; and
the report data comprises a portion of the demographic information.

19. The method of claim 1, further comprising:
determining, by the one or more processors, based upon the at least one diagnostic result, a second diagnostic algorithm of the plurality of diagnostic algorithms; and
providing, for review at a user device, an option for selecting analysis of second genetic sequencing data using the second diagnostic algorithm.

20. The method of claim 19, further comprising:
retrieving, from a second storage medium, medical record data, wherein
determining the second diagnostic algorithm of the plurality of diagnostic algorithms comprises reviewing a portion of the medical record data.

21. The method of claim 19, wherein determining the second diagnostic algorithm of the plurality of diagnostic algorithms comprises determining a popularity associated with the second diagnostic algorithm.

22. The method of claim 19, wherein determining the second diagnostic algorithm of the plurality of diagnostic algorithms comprises determining a user rating associated with the second diagnostic algorithm.

23. The method of claim 19, further comprising:
receiving an indication of selection of the second diagnostic algorithm; and
responsive to the indication of selection, analyzing, by the one or more processors, the second genetic sequencing data using the second diagnostic algorithm to obtain at least one second diagnostic result.

24. The method of claim 23, wherein the second genetic sequencing data comprises a different type than the first genetic sequencing data.

25. The method of claim 23, wherein the second genetic sequencing data comprises the first genetic sequencing data.

26. The method of claim 23, further comprising:
generating report data, wherein
the report data comprises the at least one diagnostic result and the at least one second diagnostic result, and
generating the report data comprises formatting the report data for review by a user.

27. The method of claim 1, further comprising:
prior to analyzing the first genetic sequence data, validating the first genetic sequence data.

28. The method of claim 27, wherein validating the first genetic sequence data comprises comparing a type of the first genetic sequence data to a predetermined type of genetic sequence data for use with the first diagnostic algorithm.

29. The method of claim 28, wherein the type comprises at least one of genome, transcriptome, DNA, and RNA.

30. The method of claim 29, wherein validating the first genetic sequence data comprises determining a recency of the first genetic sequence data.

31. A system comprising:
a storage medium comprising first genetic sequence data;
one or more processors; and
memory storing instructions that, when executed, cause the processor to:
receive an indication of selection of a first diagnostic algorithm of a plurality of diagnostic algorithms for analyzing genetic sequence data, wherein the indication is associated with an identifier;
retrieve, from the storage medium, the first genetic sequencing data, wherein the first genetic sequencing data is associated with the identifier; and
analyze, by the one or more processors, the first genetic sequencing data using the first diagnostic algorithm to obtain at least one diagnostic result.

32. The system of claim 31, wherein the one or more processors comprise a plurality of networked processors.

33. The system of claim 32, wherein the plurality of networked processors are distributed in a cloud network environment.

34. The system of claim 32, wherein the instructions cause at least one of the plurality of networked processors to provide the at least one diagnostic result to a remote computing device.

35. The system of claim 31, wherein the at least one diagnostic result comprises at least one of (a) resistance patterns, (b) a respiratory panel, and (c) a transplantation panel.

36. The system of claim 31, wherein each respective diagnostic algorithm of the plurality of diagnostic algorithms is associated with at least one category of a plurality of categories, the plurality of categories comprising one or more of virology, bacteriology, oncology, microbiology, and pathology.

37. A non-transitory computer readable medium, wherein the computer readable medium stores instructions that, when executed by a processor, cause the processor to:
receive an indication of selection of a first diagnostic algorithm of a plurality of diagnostic algorithms for analyzing genetic sequence data, wherein the indication is associated with an identifier;
retrieve first genetic sequencing data associated with the identifier; and
analyze the first genetic sequencing data using the first diagnostic algorithm to obtain at least one diagnostic result.

38. The computer readable medium of claim 37, wherein the processor comprises a plurality of networked processors.

39. The computer readable medium of claim 38, wherein:
the plurality of networked processors are distributed in a cloud network environment in communication with a remote computing device; and
the instructions cause at least one of the plurality of networked processors to provide the at least one diagnostic result to the remote computing device.
